(19) United States
(12) Patent Application Publication
(10) Pub. No.: US 2008/0021632 A1
(43) Pub. Date: Jan. 24, 2008

(54) Traffic Condition Report Device, System Thereof, Method Thereof, Program For Executing The Method, And Recording Medium Containing The Program

(76) Inventor: Kouji Amano, Tokyo (JP)

Correspondence Address: KRATZ, QUINTOS & HANSON, LLP, 1420 K Street, N.W., Suite 400, WASHINGTON, DC, 20005, US

(21) Appl. No.: 11/630,412

(22) PCT Filed: Jun. 27, 2005
(86) PCT No.: PCT/JP05/11718

§ 371 Date: Dec. 21, 2006

(30) Foreign Application Priority Data
Jun. 25, 2004 (JP) 2004-188700

(51) Int. Cl. G08G 1/00

(52) U.S. Cl. 701/117

(57) ABSTRACT

The navigation device 100 includes: a storage section 160 for acquiring map information; a route processor for searching for a travel route of a vehicle to acquire an arrival position of the vehicle at a predetermined time; a traffic-jam condition recognizer for recognizing current traffic-jam information and predicted traffic-jam information to recognize a traffic-jam zone; a traffic-jam avoiding section for acquiring, when recognizing that the vehicle arrives at the traffic-jam zone at a predetermined time, rest area information; and a display controller for controlling a terminal display section 140 to display the rest area information. With the arrangement, when it is predicted that the vehicle will be involved in a traffic jam, a user can avoid the traffic jam and take a rest at the rest area.

### TECHNICAL FIELD

The present invention relates to a traffic-condition notifying device for notifying traffic conditions for a mobile body, its system, its method, a program for executing the method, and a recording medium storing the program.

### BACKGROUND ART

There has been conventionally known an in-vehicle navigation device that acquires traffic information (VICS data) on traffic accidents and traffic jams etc. from a Vehicle Information Communication System (VICS) and superimposes indications representing the traffic condition such as the traffic accidents and the traffic jams on map information displayed on a screen of a display unit to notify users of the traffic condition.

As an example of such in-vehicle navigation device, there has been known an arrangement that predicts and notifies current and future traffic conditions with the use of statistical traffic-jam information data obtained by statistically processing the past traffic-jam information (see, for example, Patent Document 1).

An in-vehicle navigation device disclosed in Patent document 1 notifies statistical traffic-jam information according to time factors such as time and day of the week based on the statistical traffic-jam information data by superimposing the information on map information in various expressions corresponding to the traffic-jam condition. With the notified time and day of the week, users can predict current and possible future traffic jams.

[Patent Document 1] Japanese Laid-Open Patent Publication No. Hei 9-113290 (right column of page 3 to left column of page 7).

### DISCLOSURE OF THE INVENTION

### Problems to be Solved by the Invention

However, in the conventional arrangement for predicting the traffic condition as disclosed in Patent Document 1, only a traffic-jam condition of a certain time and day of the week can be notified to the user, so that the user cannot predict how the traffic-jam condition changes from the time onward. Accordingly, the change in the traffic-jam condition might cause inconveniences to the user, e.g., even when a traffic jam is cleared until the time the user reaches the traffic-jam, the user makes a detour at a fork before the traffic jam, the user gets involved in and thus cannot make a detour due to a traffic jam that has been grown before the user reaches the traffic jam. Thus, it is required that a traffic-jam condition around a certain time be sequentially predicted and that the user determine how the traffic jam changes based on contents of the notified traffic-jam condition, which causes a prediction of the traffic-jam condition for a proper travel to become bothersome.

An object of the present invention is to provide a traffic-condition notifying device capable of supporting a proper travel, its system, its method, its program, and a recording medium storing the program.

### Means for Solving the Problems

A traffic-condition notifying device according to an aspect of the present invention includes: a map information acquirer for acquiring map information; a current position recognizer for acquiring current position information about a current position of a mobile body; a destination recognizer for recognizing destination information about a destination; a route searcher for searching for a travel route of the mobile body from the current position to the destination; a traffic-information recognizer for recognizing traffic information about a traffic condition; a statistical-traffic-information acquirer for acquiring statistical traffic information that is obtained by statistically processing traffic conditions in the past based on time factors; a traffic-jam-condition change recognizer for recognizing a change over time in the traffic condition of travel traffic jam of the mobile body based on the statistical traffic information; an arrival position recognizer for recognizing a predicted arrival position of the mobile body at a predetermined time; a predicted traffic-jam position recognizer for recognizing a predicted traffic-jam position at a predetermined time that is estimated based on the change over time in the traffic condition; a stop-off information acquirer for acquiring, when determining that the mobile body arrives at the predicted traffic-jam position based on the predicted arrival position of the mobile body and the predicted traffic-jam position, stop-off information regarding a stop-off point located in a predetermined distance area from the travel route; and a notification controller for controlling a notifier to notify the stop-off information.

A traffic-condition notifying system according to another aspect of the present invention includes: a server unit that stores map information in a storage section; and a terminal unit including the above-described traffic-condition notifying device of the present invention for acquiring map information from a server unit over a network.

A traffic-condition notifying system according to still another aspect of the present invention includes: a terminal unit including the above-described traffic-condition notifying device of the present invention; and a portable device connected to the terminal unit via a network to enable communication therebetween, the portable device including a notifier for notifying the departure notification information that is acquired from the traffic-condition notifying device via the network.

A traffic-condition notifying system according to yet another aspect of the present invention includes: a server unit; and a terminal unit, the server including: a current position recognizer for recognizing current position information about a current position of a mobile body; a destination recognizer for recognizing destination information about a destination; a route searcher for searching for a travel route of the mobile body from the current position to the destination; a traffic-information recognizer for recognizing traffic information about a traffic condition; a statistical-traffic-information acquirer for acquiring statistical traffic information that is obtained by statistically processing traffic conditions in the past based on time factors; a traffic-jam-condition change recognizer for recognizing a change over time in the traffic condition of travel traffic jam of the mobile body based on the statistical traffic information; an arrival position recognizer for recognizing a predicted arrival position of the mobile body at a predetermined time; a predicted traffic-jam position recognizer for recognizing a predicted traffic-jam position at a predetermined time that is estimated based on the change over time in the traffic condition; and a stop-by information acquirer for acquiring, when determining that the mobile body arrives at the predicted traffic-jam position based on the predicted arrival position of the mobile body and the predicted traffic-jam position, stop-by information regarding a stop-by point located in a predetermined distance area from the travel route, the terminal unit including: a transceiver for acquiring the map information and the stop-off information from the server unit via a network; and a notifier for notifying the stop-off-point information.

A traffic-condition notifying method according to further aspect of the present invention includes: recognizing a change over time in a traffic condition based on statistical traffic information that is obtained by statistically processed map information, current position information of a mobile body, destination information, traffic information about a traffic condition and a traffic condition in the past based on time factors; searching for a travel route from a current position of the mobile body to a destination; and when determining that, based on a predicted traffic-jam position at a predetermined time that is estimated based on a predicted arrival position of the mobile body at a predetermined time and the change over time in the traffic condition, the mobile body arrives at the predicted traffic-jam position, and determining that the mobile body will be involved in a traffic jam at a predetermined time, acquiring stop-off information about a stop-off point in a predetermined distance area from the travel route to notify the stop-off information by the notifier.

A traffic-condition notifying program according to still further aspect of the present invention operates a computing unit to execute the above-described traffic-condition notifying method of the present invention.

A recording medium according to yet further aspect of the present invention stores the above-described traffic-condition notifying program of the present invention in a manner readable by a computing unit

### BRIEF DESCRIPTION OF DRAWINGS

FIG. 1 is a block diagram schematically showing an arrangement of a navigation device according to a first embodiment of the present invention;

FIG. 2 is a conceptual diagram schematically showing a table structure of display data of map information according to the first embodiment;

FIG. 3 is a conceptual diagram schematically showing a table structure of matching data of the map information according to the first embodiment;

FIG. 4 is a conceptual diagram schematically showing a table structure of data in a traffic-jam prediction table according to the first embodiment;

FIG. 5 is a conceptual diagram schematically showing a table structure of data in a rest-area-type table according to the first embodiment;

FIG. 6 is a block diagram schematically showing an arrangement of a processor of the navigation device according to the first embodiment;

FIG. 7 is a flowchart showing search processing for a travel route in the navigation device according to the first embodiment;

FIG. 8 is an illustration schematically showing a display example of a terminal display section displaying guidance for navigating a vehicle to a rest area by avoiding a traffic jam occurring currently according to the first embodiment;

FIG. 9 is an illustration schematically showing another display example of the terminal display section displaying guidance for navigating the vehicle to a rest area by avoiding a zone with occurrence of a traffic jam being predicted according to the first embodiment;

FIG. 10 is a still another display example of the terminal display section displaying guidance for navigating the vehicle to a rest area by avoiding a traffic jam on a highway according to the first embodiment;

FIG. 11 is a block diagram briefly showing an arrangement of a navigation system according to a second embodiment of the present invention;

FIG. 12 is a block diagram schematically showing an arrangement of a terminal unit according to the second embodiment;

FIG. 13 is a block diagram schematically showing an arrangement of a processor of the terminal unit according to the second embodiment;

FIG. 14 is a block diagram schematically showing an arrangement of a server unit according to the second embodiment;

FIG. 15 is a block diagram schematically showing an arrangement of a CPU of the server unit according to the second embodiment; and

FIG. 16 is a flow chart showing how a travel route is searched for according to the second embodiment.

### EXPLANATION OF CODES

100 navigation device as traffic-condition notifying device
140 terminal display section as notifier
150 sound output section as notifier
181 current position recognizer
182 destination recognizer
185, 553 traffic-jam condition recognizer also serving as traffic-information recognizer, statistical-traffic-information acquirer, traffic-jam-condition change recognizer, predicted traffic-jam position recognizer and an estimated time information acquirer
186, 554 route processor also serving as route searcher, arrival position recognizer, traffic-jam-passing-time recognizer and estimated required-time calculator
187, 555 traffic-jam avoiding section as stop-off information acquirer
190 display controller as map information acquirer and notification controller
191 timer
200 navigation system as traffic condition notifying system
300 network
400 terminal unit
500 server unit
540 storage section

### BEST MODE FOR CARRYING OUT THE INVENTION

### First Embodiment

Now, a first embodiment of the present invention will be described with reference to the attached drawings.

A navigation device of this embodiment is an example of a traffic-condition notifying device of the present invention, which is designed to navigate a mobile body (e.g. a vehicle) for driving as a travel progress thereof. It should be noted that the traffic-condition notifying device of the present invention is not necessarily designed to navigate a vehicle for the driving thereof, but may be so designed to notify a traffic condition for any type of mobile body.

[Arrangement of Navigation Device]

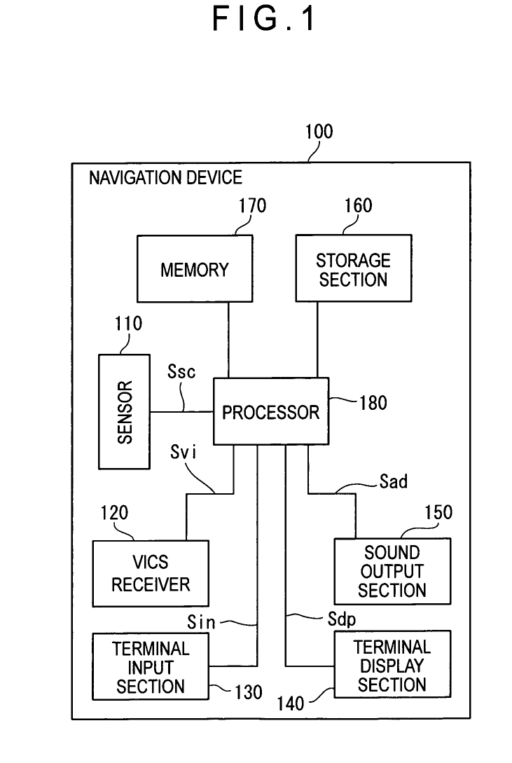

Referring to FIG. 1, the reference numeral 100 denotes the navigation device as a traffic-condition notifying device. The navigation device 100 notifies guidance on a travel along with a travel progress of a mobile body (e.g. a vehicle). The mobile body is not limited to vehicles, but includes any type of mobile body such as aircrafts and ships. The navigation device 100 may be, for example, an in-vehicle unit installed in a vehicle as a mobile body, a portable unit, a PDA (Personal Digital Assistant), a portable phone, a PHS (Personal Handyphone System) or a portable personal computer. The navigation device 100 searches for and displays information about a current position and a destination, a route to the destination, predetermined shops nearby, and information about services offered by the shops based on map information stored in the navigation device 100. As shown in FIG. 1, the navigation device 100 has a sensor 110, a VICS (Vehicle Information Communication System) receiver 120, a terminal input section 130, a terminal display section 140 (notifier), a sound output section 150 (notifier), a storage section 160, a memory 170, a processor 180 and so on.

The sensor 110 detects the travel progress of a mobile body (e.g. a vehicle), or the current position and the driving status, and outputs it as a predetermined signal Ssc to the processor 180. The sensor 110 typically has a GPS (Global Positioning System) receiver (not shown) and various sensors such as a speed sensor, an azimuth sensor and an acceleration sensor (each not shown).

The GPS receiver receives electric navigation waves output from a GPS satellite (not shown), which is an artificial satellite, via a GPS antenna (not shown). Then, the GPS receiver computes simulated coordinate values of the current position based on a signal corresponding to the received electric navigation waves and outputs the simulated coordinate values as a GPS data to the processor 180.

The speed sensor of the sensor 110 is arranged on the mobile body (e.g. a vehicle) so as to detect driving speed and actual acceleration of the vehicle based on a signal that varies depending on travel speed or driving speed of the vehicle. The speed sensor reads a pulse signal, a voltage value and the like output in response to the revolution of axles and wheels of the vehicle. Then, the speed sensor outputs detection information such as the read pulse signal and voltage value to the processor 180. The azimuth sensor is arranged on the vehicle and provided with a so-called gyro-sensor (not shown) so as to detect the azimuth of the vehicle, i.e., a driving direction for which the vehicle is heading. The azimuth sensor outputs a signal representing detection information about the detected driving direction to the processor 180. The acceleration sensor is arranged on the vehicle so as to detect the acceleration of the vehicle in the driving direction thereof. The acceleration sensor converts the detected acceleration into a sensor output value, which is detection information such as the pulse and the voltage, and then outputs the sensor output value to the processor 180.

The VICS receiver 120 has a VICS antenna (not shown) and acquires information about the traffic via the VICS antenna. More specifically, the VICS receiver 120 acquires traffic information (hereinafter referred to as VICS data) about traffic jams, traffic accidents, constructions, traffic controls and so on from the VICS (not shown) by way of a beacon, FM multiplex broadcasting or the like. The acquired information about traffic is output as a predetermined signal Svi to the processor 180.

The VICS data is structured in a table typically containing a plurality of following conceptual items formed as a single data structure.

traffic-jam level: traffic-jammed, crowded, smooth, etc.

top position information of traffic jam

length information of traffic jam

link travel time information: travel time required for a vehicle to pass through a VICS link (distance between intersections)

zone travel time information: travel time required for a vehicle to pass through a zone longer than a VICS link

information about traffic controls, causes thereof, controlled areas

information about availability of parking areas

information about service areas and parking areas

other information

The terminal input section 130, which may be a keyboard, a mouse or the like, has various operation buttons and operation knobs (each not shown) to be used for input operations. The operation buttons and the operation knobs are used to input, for example, the settings for the operations of the navigation device 100. More specifically, the operation buttons and the operation knobs may be used: to set the contents of information to be acquired and acquiring criteria; to set a destination; to retrieve information; and to display the driving status (travel progress) of the vehicle. When the settings are input, the terminal input section 130 outputs a predetermined signal Sin to the processor 180 so as to apply the settings. In place of the input operation using the operation buttons and the operation knobs, the terminal input section 130 may employ input operation using a touch panel arranged on the terminal display section 140, sound input operation and the like for inputting various settings.

The terminal display section 140, under the control of the processor 180, displays image data transmitted from the processor 180. Examples of the image data may include image data representing map information and retrieval information, TV image data received by a TV receiver, image data stored in an external device or recording medium such as an optical disc, a magnetic disc or a memory card and read by a drive or a driver, and image data in the memory 170. The terminal display section 140 may typically be a liquid-crystal, an organic EL (Electro Luminescence) panel, a PDP (Plasma Display Panel), or a CRT (Cathode-Ray Tube).

The sound output section 150 has an audio section such as a speaker (not shown). The sound output section 150, under the control of the processor 180, outputs various signals Sad as sounds from the audio section. The various signals Sad represent sound data etc. sent from the processor 180. Information output as sounds, which may be the driving direction and the driving status of the vehicle and traffic condition, are notified to occupants such as a driver of the vehicle for navigating the vehicle. The audio section may output TV sound data received by a TV receiver (not shown) and sound data stored in a recording medium or the memory 170. In place of the audio section provided to the sound output section 150, the sound output section 150 may use an audio section equipped on the vehicle.

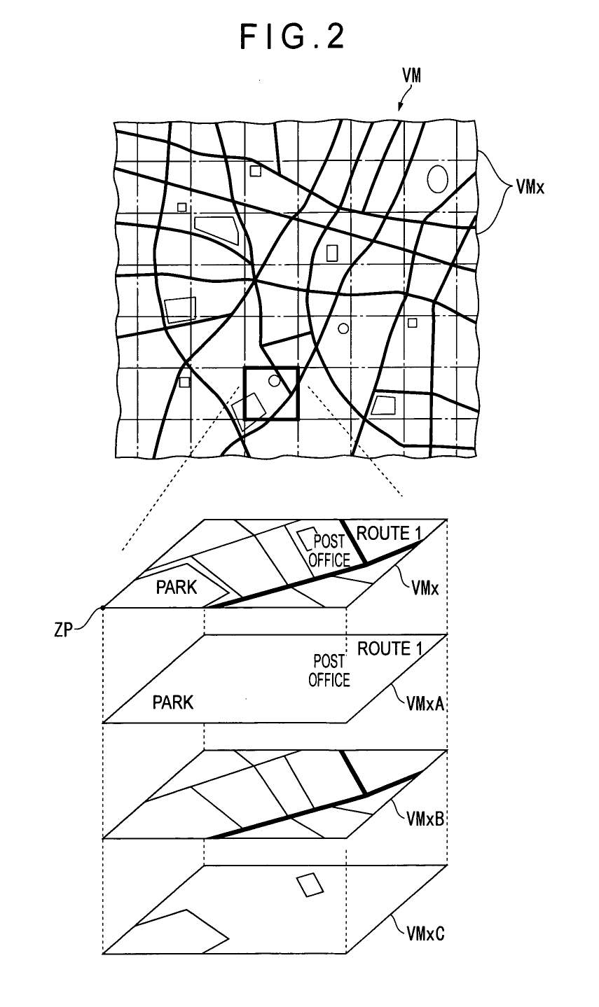

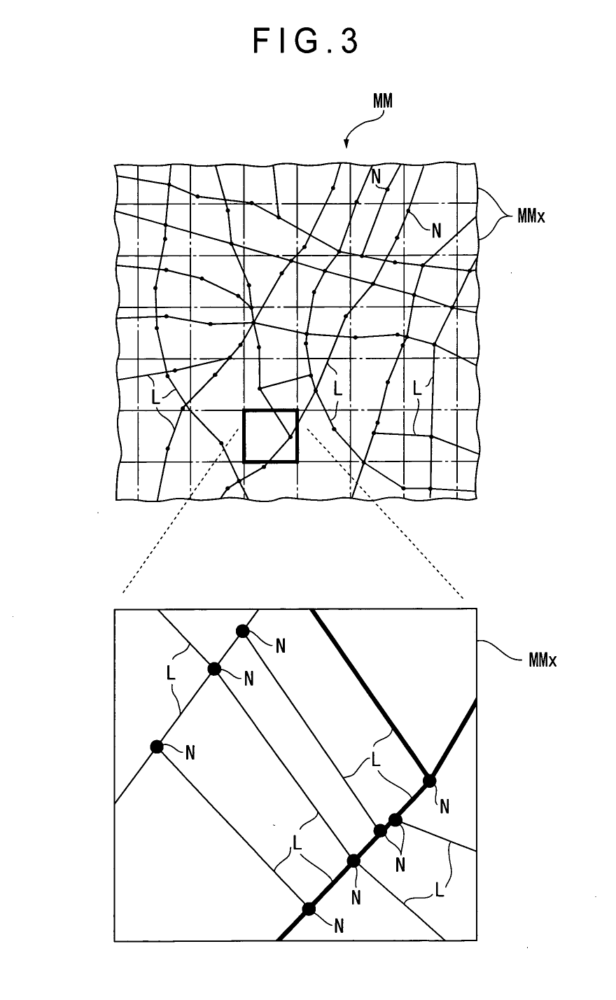

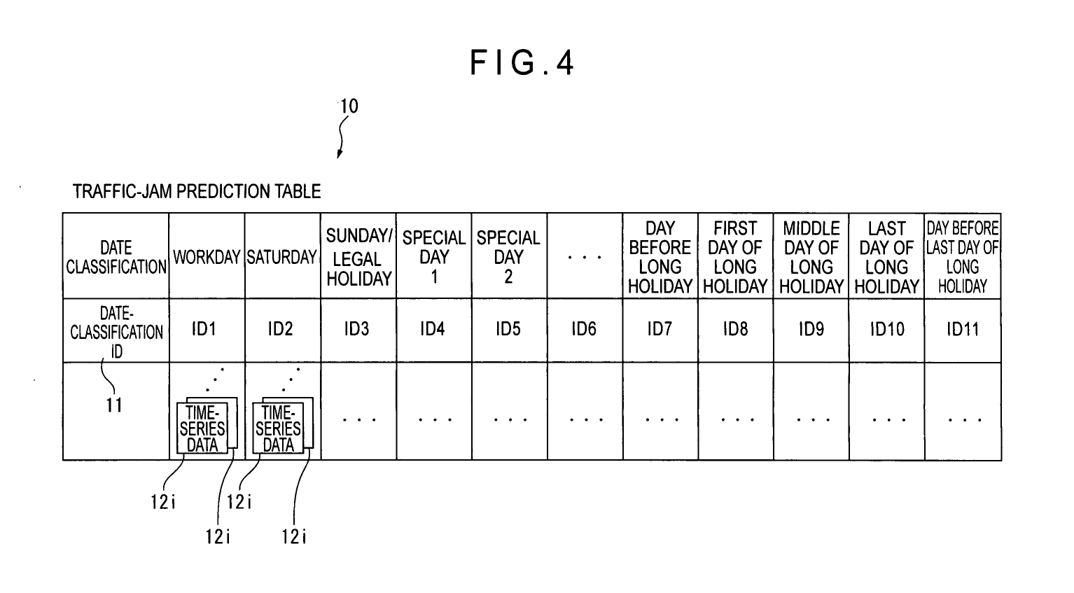

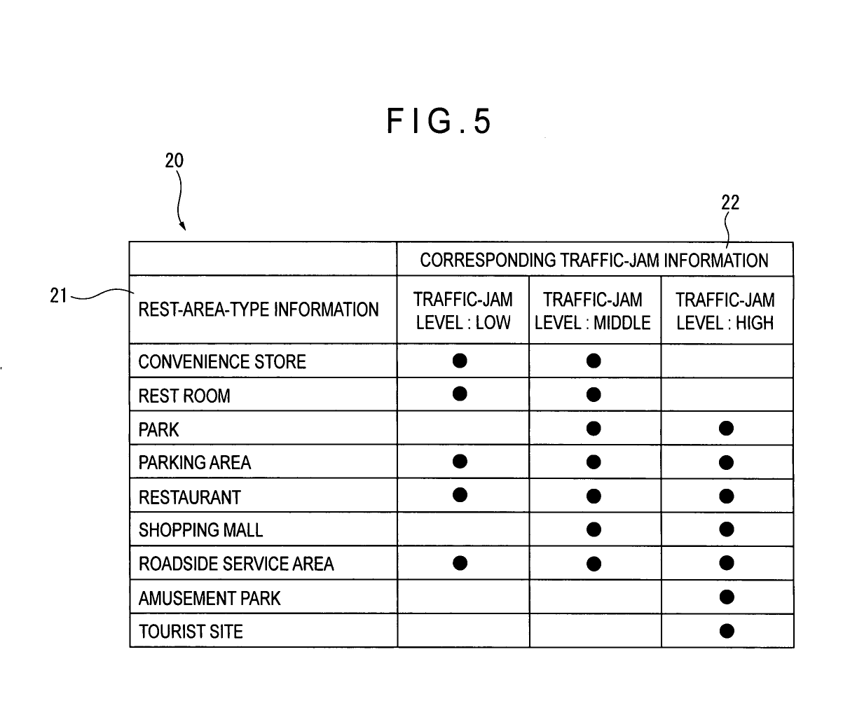

The storage section 160 readably stores map information as shown in FIGS. 2 and 3, a traffic-jam prediction table 10 as shown in FIG. 4, a rest-area-type table 20 as shown in FIG. 5, etc. Although not shown, the storage section 160 includes a map information storage area for storing the map information, a traffic-jam prediction table storage area for storing the traffic-jam prediction table 10, etc. While the storage section 160 has the above-described two storage areas in the above description, the storage section 160 may not have any of the above-described storage areas, or may have additional storage areas. The storage section 160 may include drives or drivers for readably storing data on recording medium such as a HD (Hard Disk), a DVD (Digital Versatile Disc), an optical disc and a memory card.

The map information includes display data VM, which is so-called POI (Point Of Interest) data as shown in FIG. 2, matching data MM as shown in FIG. 3, route-search map data and the like.

The display data VM includes, for example, plural pieces of display mesh information VMx, each having a unique number. To be more specific, the display data VM is divided into the plural pieces of display mesh information VMx, each relating to an area. The display data VM is constituted from the plural pieces of display mesh information VMx continuously arranged in a matrix form. The display mesh information VMx may be further divided into plural pieces of display mesh information VMx to be contained in a lower layer, each relating to a smaller area.

The display mesh information VMx is, for instance, constituted from name information VMxA such as intersection names, road information VMxB and background information VMxC. The name information VMxA is data structured in a table for arranging and displaying miscellaneous element data (e.g. intersection name, town name) contained in an area at a predetermined position with reference to a positional relationship based on the absolute coordinates ZP. The road information VMxB is data structured in a table for arranging and displaying road element data (e.g. road) contained in an area at a predetermined position with reference to a positional relationship based on the absolute coordinates ZP. The background information VMxC is data structured in a table for arranging and displaying miscellaneous element data (e.g. mark and image information representing famous spots and buildings) at a predetermined position with reference to a positional relationship based on the absolute coordinates ZP.

The matching data MM, just like the display data VM, is divided into plural pieces of matching mesh information MMx, each having a unique number and relating to an area. The matching data MM is constituted from the plural pieces of matching mesh information MMx continuously arranged in a matrix form. The matching mesh information MMx may be further divided into plural pieces of matching mesh information MMx to be contained in a lower layer, each relating to a smaller area. Each matching mesh information MMx has a rectangular shape with each side thereof having a predetermined length, which is reduced relative to the actual geographic length according to the map scale. A predetermined corner thereof contains absolute coordinates ZP in the whole map information, e.g., a global map.

The matching data MM is used for map matching processing for correcting the displayed information to locate a mark representing the vehicle on a road, when the travel progress of the vehicle is superposed on the map information. This processing prevents such errors in which the mark representing the vehicle is displayed on a building instead of the road. The matching data MM has plural pieces of link string block information.

As shown in FIG. 4, the link string block information is data structured in a table so that a plurality of links L as segment information are mutually associated according to a predetermined rule, the link L representing a road as a segment and connecting nodes N representing points. Specifically, the links L each corresponding to a predetermined length of a road are mutually connected to form polygonal lines (i.e. link strings), which represent continuous roads such as Koshu street and Ome street. Each link L has segment-specific information (hereafter referred to as a link ID) as a unique number assigned to each link L, and node information as a unique number indicating two nodes N connected by the link L.

Further, the link string block information of the matching data MM is associated with information about the road structure that describes, for example, the number of lanes, whether it is a main line or not, whether it is a national road or a state road, a road type such as a toll road, a tunnel structure and the like. Based on the information about the road structure, roads can be displayed on a map corresponding to the display data VM.

The route-search map information is structured in a table, which is similar to that of the matching data MM, including point information for representing points such as the nodes N for representing roads, and segment information for connecting points such as the links L. The information is so structured to represent roads for searching for a travel route.

The traffic-jam prediction table 10, which includes statistical traffic information obtained by statistically processing the past traffic conditions based on time factors, is a data group for showing traffic conditions in the past at an arbitrary spot. The traffic-jam prediction table 10 is used to predict a traffic-jam condition at route search processing and at processing for displaying a map. The traffic-jam prediction table 10, as shown in FIG. 4, is structured in a table storing a plurality of records, each single record containing a date-classification ID (identification) 11, time-series data 12i (i representing a natural number) and the like.

The date-classification ID 11 is typically an ID number representing a classification of date and day of the week. In the following description, classification of date and day of the week will be referred to as date classification. For example, “ID1” may indicate any “workday” such as Monday to Friday excluding legal holidays; “ID2” may indicate “Saturday” excluding legal holidays; “ID4” may indicate “special day 1” such as a festival day of City a; “ID5” may indicate “special day 2” such as a day when a sports meeting is held at Athletic Ground b; “ID7” may indicate “day before a long holiday” such as the day before four consecutive holidays; and “ID11” may indicate “day before the last day of a long holiday” such as the third day of four consecutive holidays. The date-classification ID 11 is not limited to the ID number, but may be text data directly related to a day such as “workday”.

The time-series data 12i is data on the tendency of the traffic-jam condition of the traffic conditions. For example, VICS data may be acquired from the VICS and stored for each VICS link, and then statistically processed for, for instance, every 10 minutes based on the time factor of the stored VICS link (i.e. date classification) so as to be used as the time-series data 12i.In other words, the time-series data 12i is data representing the traffic-jam condition at arbitrary spots (which might be each VICS link) for every predetermined time, such as the length of the traffic jam, the time required for passing through the traffic jam, the time required for the traffic jam to be cleared up, etc. While the time-series data 12i described above is data generated by statistically processing the data for each spot based on the time factor, it may alternatively be generated for each facility, shop, area, city and town, or road. The time-series data 12i may not be limited to various information related to the traffic jam, but may be, for instance, information containing congestion information related to a congestion level of a parking area of a rest area for every predetermined time based on information related to availability of the parking area received by the VICS receiver 120.

The rest-area-type table 20 is a data group showing information related to a rest area as a stop-off point corresponding to the traffic-jam level of the traffic jam. The rest-area-type table 20 is used to select rest area information as stop-off information. The rest-area-type table 20, as shown in FIG. 5, is structured in a table storing a plurality of records, each single record containing rest-area-type information 21, corresponding traffic-jam information 22 and the like.

The rest-area-type information 21 is information related to a type of a rest area. The rest-area-type information 21 includes, as shown in FIG. 5, point information about shops, tourist sites and public accommodations (e.g., convenience stores, rest rooms, parking areas, parks, restaurants, shopping malls and amusement parks), the point information being generally categorized by type. The rest area information is retrieved based on the rest-area-type information 21.

The corresponding traffic-jam information 22 is information related to a traffic-jam level of the traffic jam corresponding to the rest-area-type information 21. The corresponding traffic-jam information 22 shows, for instance, to which traffic-jam level the rest-area-type information 21 corresponds. For example, in FIG. 5, corresponding traffic-jam information 22 of “convenience store” corresponds to traffic jams of low and middle traffic-jam levels, while corresponding traffic-jam information 22 of “amusement park” corresponds to a traffic jam of high traffic-jam level. Note that the corresponding traffic-jam information 22 can be arbitrarily set by the user. For instance, in a case where the user desired to be navigated to an amusement park even when the traffic-jam level is not so high, the corresponding traffic-jam information 22 of “amusement park” may be rewritten to information corresponding to the middle traffic-jam level by user's input.

The storage section 160 typically stores the retrieval information for acquiring information of a predetermined point in the map information. More specifically, the retrieval information includes various information about contents and guidance such as names of states, cities and towns, regions and points, which are units used to gradually divide the map information into smaller areas, as well as various information about shops as points. The retrieval information is structured in a tree structure table so that plural pieces of item information are hierarchically associated with each other.

The memory 170 readably stores the settings that are input by the terminal input section 130, music data and image data, a calendar template (not shown) and the like. The memory 170 also stores various programs that run on the OS (Operating System) controlling the whole operation of the navigation device 100. The memory 170 may preferably be a CMOS (Complementary Metal-Oxide Semiconductor) memory that retains the stored data even in the case of, for instance, a sudden power interruption caused by a blackout. The memory 170 may include drives or drivers for readably storing data on a recording medium such as a HD, a DVD, and an optical disc.

The calendar template is a template representing a date classification of each date. More specifically, the calendar template is structured in a table storing plural pieces of table data for every month, typically twelve pieces of table data. The respective pieces of table data have a plurality of records, each containing date information about a date, a classification ID number associated with the date of the date information. The classification ID numbers have contents corresponding to the date-classification ID 11 of the traffic-jam prediction table 10.

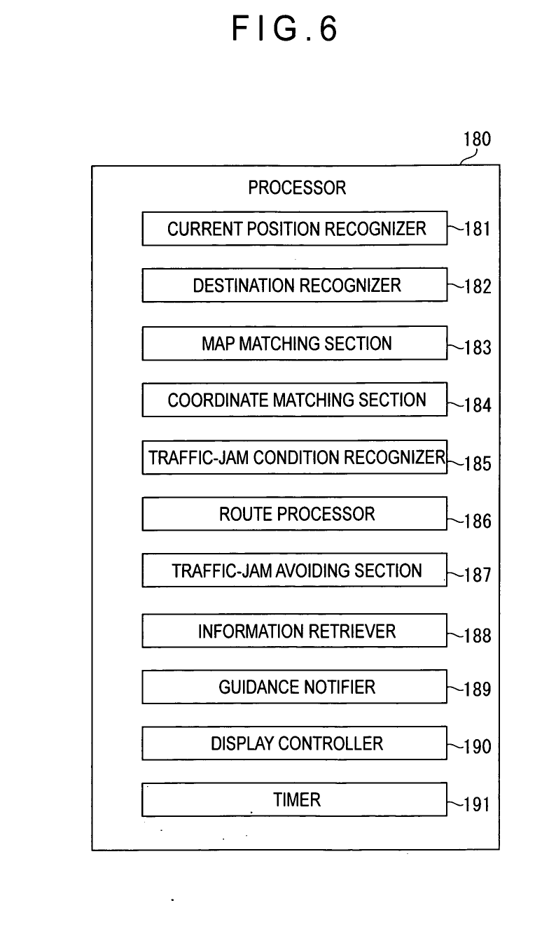

The processor 180 has various input/output ports (not shown) including a VICS receiving port connected to a VICS antenna, a GPS receiving port connected to a GPS receiver, sensor ports respectively connected to various sensors, a key input port connected to the terminal input section 130, a display control port connected to the terminal display section 140, a sound control port connected to the sound output section 150, a storage port connected to the storage section 160 and a memory port connected to the memory 170. As shown in FIG. 6, the processor 180 has various programs such as a current-position recognizer 181, a destination recognizer 182, a map matching section 183, a coordinate matching section 184, a traffic-jam condition recognizer 185 also serving as a traffic-information recognizer, a statistical-traffic-information acquirer, a traffic-jam-condition change recognizer, a predicted traffic-jam position recognizer and an estimated time information acquirer, a route processor 186 also serving as a route searcher, an arrival position recognizer, a traffic-jam-passing-time recognizer and an estimated-required-time computing section, a traffic-jam avoiding section 187 as a stop-off information acquirer, an information retriever 188, a guidance notifier 189 as a notification controller, a display controller 190 also serving as a map information acquirer and a notification controller, a timer 191 and so on.

The current-position recognizer 181 recognizes the current position of the vehicle. More specifically, the current-position recognizer 181 calculates a plurality of current simulated positions of the vehicle on the basis of the speed data and the azimuth data of the vehicle output respectively from the speed sensor and the azimuth sensor of the sensor 110. The current-position recognizer 181 further recognizes the current simulated coordinate values of the vehicle based on the GPS data on the current position output from the GPS receiver. Then, the current-position recognizer 181 compares the calculated current simulated positions with the recognized current simulated coordinate values, and calculates the current position of the vehicle on map information separately acquired so as to recognize the current position.

The current-position recognizer 181 determines a slope angle and an altitude of a road to drive based on the acceleration data output from the acceleration sensor and calculates the current simulated position of the vehicle so as to recognize the current position. Thus, the current position of the vehicle can be accurately recognized even if the vehicle is on an intersection with an overpass or on an elevated highway where roads are overlaid in a two-dimensional view. Furthermore, when the vehicle runs on a mountain road or a slope, the current-position recognizer 181 corrects the discrepancy between the travel distance obtained based only on the speed data and the azimuth data and the actual travel distance by using the detected slope angle of the road to accurately recognize the current position.

The current-position recognizer 181 can recognize not only the current position of the vehicle as described above but also a departure point, i.e. an initial point set by the terminal input section 130 as the current simulated position. Various information acquired by the current-position recognizer 181 are appropriately stored in the memory 170.

The destination recognizer 182 typically acquires the destination information about the destination set by the input operation at the terminal input section 130 and recognizes the position of the destination. The destination information to be set includes various information for identifying a spot, which might be coordinates such as latitude and longitude, addresses, telephone numbers and the like. Such destination information recognized by the destination recognizer 182 is appropriately stored in the memory 170.

The map matching section 183 performs the map matching processing for displaying the current position recognized by the current-position recognizer 181 based on the map information obtained from the storage section 160. As described earlier, the map matching section 183 typically uses the matching data MM for performing the map matching processing to modify or correct the current position information to prevent the current position superimposed on the map on the terminal display section 140 from being located off the road in the map on the terminal display section 140.

The coordinate matching section 184 performs the coordinate matching processing for determining whether or not point information about nodes N contained in the matching data MM of the map information acquired from the storage section 160 indicate an identical point. In other words, as described earlier, the coordinate matching section 184 acquires point information of nodes N contained in the matching data MM and reads the coordinate information of the point information. More specifically, the coordinate matching section 184 calculates the coordinate values such as the latitude and the longitude based on the coordinate values of the coordinate information and the offset amount. If different nodes N have identical coordinate values, it reads the flag information of the point information of the nodes N to determine whether the nodes N represent the identical point. If the coordinate matching section 184 determines that the nodes N are identical, it recognizes a road arrangement in which the links L respectively connected to the nodes N and contained in the different link string block information are crossed with each other, and thus considers as, for example, an intersection. If, on the other hand, the coordinate matching section 184 determines that the nodes N are not identical, it recognizes a road arrangement in which the links L respectively connected to the nodes N and contained in the different link string block information are not crossed with each other, and thus considers as, for example, a multi-level intersection.

The traffic-jam condition recognizer 185 generates current traffic-jam information about the traffic jam that currently occurs. More specifically, the traffic-jam condition recognizer 185 appropriately acquires the VICS data from the VICS output from the VICS receiver 120. Then, based on the acquired VICS data, it generates current traffic-jam information about the traffic jam that are currently present in an area including, for example, the current position and the destination or in a predetermined area around the current position.

Additionally, the traffic-jam condition recognizer 185 obtains the estimated arrival time as an estimated time to arrive at an arbitrary spot on the route to the destination. For instance, the traffic-jam condition recognizer 185 obtains the estimated arrival time as an estimated time to arrive at an arbitrary spot on the route to the destination. Then, based on the obtained estimated arrival time, a preset scheduled time, the time-series data 121 etc., the traffic-jam condition recognizer 185 generates traffic-jam prediction information about predictions of the traffic jam that may arise at the arbitrary spot before arriving at the destination or at the preset scheduled time.

Further, the traffic-jam condition recognizer 185 acquires traffic-jam-clearance required time, which is a time required for the traffic jam that is currently present or the traffic jam that is predicted to arise to be cleared up. Specifically, based on the time-series data 12i of the traffic-jam prediction table 10, the traffic-jam condition recognizer 185 obtains an estimated traffic-jam clearing time at which the traffic jam is estimated to be cleared up. Then, difference between the current time and the traffic-jam clearing time or difference between time at which the traffic jam is predicted to arise and the traffic-jam clearing time is computed to obtain the traffic-jam-clearance required time.

The route processor 186 searches for a travel route by computing the driving route of the vehicle based on the setting information that is set by user for setting the route as well as the map information stored in the storage section 160. Specifically, the route processor 186 acquires the current position, the destination or the rest area, the setting information, the current traffic-jam information, the traffic-jam prediction information and the like. Then, based on the acquired information, the route processor 186 searches for available roads, where for example traffic is allowed, using the route-search map information of the map information, and generates travel route information for setting a route with a shorter required time, a route with a shorter distance, or a route without traffic jam and traffic controls. After that, the route processor 186 determines the time required to arrive at the destination or the rest area for each of the routes contained in the travel route information and generates required-time information about the required time. The route processor 186 acquires an arrival position at which the vehicle arrives at a predetermined time based on the speed information of the vehicle that is acquired by the sensor 110. In addition, where there is a traffic-jam zone or a zone that is predicted to get a traffic jam on each of the routes contained in the travel route information, the route processor 186 computes and acquires a traffic-jam passing time required to pass through the traffic jam based on the traffic-jam prediction information

In the step of searching for the travel route, the route processor 186 might use the matching data MM of the map information in addition to the route-search map information. This applies to, for instance, a case where the route processor 186 searches for the travel route including a narrow road such as a back street which is not contained in the route-search map information. When the matching data MM is used, the route is appropriately searched according to the road arrangement recognized by the coordinate matching section 184. The travel route information typically includes route guidance information for navigating the vehicle during the drive thereof for assisting the drive. Under the control of the guidance notifier 189, the route guidance information may be appropriately displayed on the terminal display section 140 or output as sounds from the sound output section 150 to assist the drive.

When the traffic-jam avoiding section 187, based on the arrival position of the vehicle at the predetermined time acquired by the route processor, estimates that the vehicle arrives at a traffic-jam zone contained in the current traffic-jam information and the predicted traffic-jam information recognized by the traffic-jam condition recognizer 185, the traffic-jam avoiding section 187 performs processing for navigating the vehicle to a rest area remote from the traffic-jam zone.

Specifically, upon recognizing traffic-jam avoidance request information from the setting information that is set by the user, the traffic-jam avoiding section 187 selects rest-area-type information 21 based on the rest-area-type table 20. At this time, the traffic-jam avoiding section 187 recognizes a traffic-jam level based on the traffic-jam clearance time, length of the traffic jam and the like to select rest-area-type information 21 having corresponding traffic-jam information 22 corresponding to the recognized traffic-jam level. The traffic-jam avoiding section 187 acquires rest area information corresponding to the selected rest-area-type information based on the map information. Specifically, the traffic-jam avoiding section 187 operates the route processor 186 to compute to acquire travel distance and travel time to the rest area. Then, based on the rest-area-type information 21, the traffic-jam avoiding section 187 estimates a rest time for the user to take a rest at the rest area. The rest time is preset in accordance with the rest-area-type information 21, e.g., 10 minutes when the rest-area-type information 21 is “convenience store” and two hours when rest-area-type information 21 is “amusement park”. The traffic-jam avoiding section 187 then compares a total time required for a round trip between the travel route to the destination and the rest area and the rest time with the traffic-jam-clearance required time, and selects and acquires rest area information such that the total time and the traffic-jam-clearance required time become substantially equal.

The traffic-jam avoiding section 187 recognizes rest-area status information about a status of the rest area (e.g., congestion level) based on, for instance, availability of a parking area received by the VICS receiver 120, the traffic-jam avoiding section 187 preferentially selecting rest area information about a rest area with low congestion level.

The information retriever 188 hierarchically retrieves and acquires the retrieval information, e.g., the point information such as shops and facilities or the rest area information stored in the storage section 160 based on the item information in response to, for example, a retrieval request for the retrieval information set at the terminal input section 130 or a rest area retrieval request from the traffic-jam avoiding section 187.

The guidance notifier 189 notifies guidance stored in the memory 170 by an image display using the terminal display section 140 or by sound using the sound output section 150 based on travel route information and feature guidance information acquired in advance according to the driving status. The guidance is related to the travel of the vehicle, which may be the contents for assisting the drive of the vehicle. Specifically, for instance, a predetermined arrow or a symbol may be displayed in a display screen of the terminal display section 140, or guidance such as “Turn right in 700 meters at intersection XXX toward YYY”, “You have deviated from the travel route.” and “Traffic-jam ahead” is output by sound from the sound output section 150.

The display controller 190 appropriately controls the terminal display section 140 to display the various information thereon. The display controller 190 also controls display of various display screens for prompting the user to operate the terminal input section 130 so as to set various information.

The timer 191 recognizes the current time typically based on a reference pulse of an internal clock. Then, the timer 191 appropriately outputs time information about the recognized current time.

[Operation of Navigation Device]

Now, the operation of the navigation device 100 will be described with reference to the drawings.

(Search Processing for Travel Route)

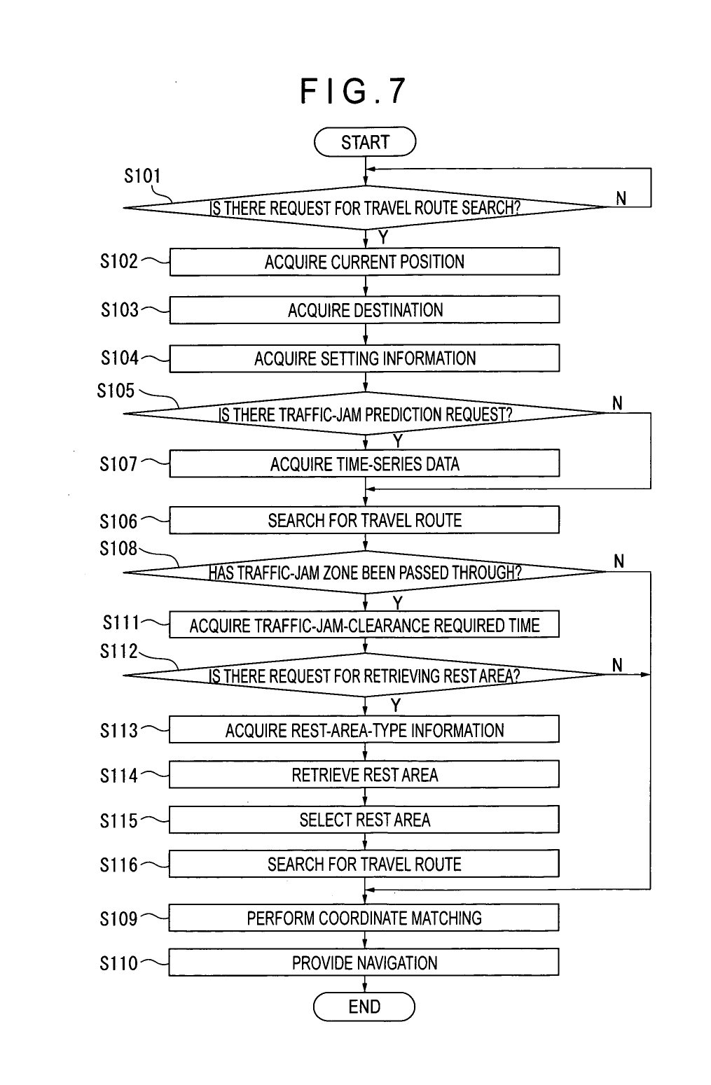

Now, the search processing for a travel route as one of operations of the navigation device 100 will be described with reference to FIG. 7.

Firstly as shown in FIG. 7, the user operates the terminal input section 130 to set a command for search processing for a travel route. When the processor 180 recognizes the set command for the search processing for the travel route (Step S101), the processor 180 displays a screen on the terminal display section 140 for prompting the user to set various information necessary for travel route search such as the destination, the setting information about the preference for shortest travel distance or shortest travel time and the necessity of traffic-jam prediction.

The processor 180, upon recognition of the various information required for the travel route search, performs processing for recognizing the current position with the current position recognizer 181 (Step S102). Specifically, the current-position recognizer 181 calculates the current position of the vehicle based on the speed data and the azimuth data of the vehicle respectively output from the speed sensor and the azimuth sensor of the sensor 110 and the GPS data about the current position output from the GPS receiver, and acquires the current position information. The acquired current position information is appropriately stored in the memory 170.

The processor 180 controls the terminal display section 140 to display a screen for prompting the user to set the destination with the input operation at the terminal input section 130. Then, when the user sets the destination by operating the terminal input section 130 following the instructions on the display screen, the destination recognizer 182 acquires destination information about the set destination (Step S103). The acquired destination information is appropriately stored in the memory 170.

If the user requests to acquire point information about a point of the destination in the step of inputting the destination by operating the terminal input section 130, the user operates the terminal input section 130 so as to request the retrieval information of the point following the instructions on the screen displayed on the terminal display section 140. In response to the retrieval request for the retrieval information of the point, the processor 180 operates the information retriever 188 to hierarchically retrieve the retrieval information about the destination from the mesh information at the lower layers for each area, typically using the map information MP and acquire the retrieval information associated with the point of the destination from the storage section 160. Then, the processor 180 controls the terminal display section 140 to display the acquired retrieval information.

The processor 180 controls the terminal display section 140 to display a screen for prompting the user to input the settings, i.e., criteria for the travel route search. When the user inputs the settings by operating the terminal input section 130 following the instruction on the display screen, the processor 180 acquires the setting information about the settings that have been input (Step S104). The acquired setting information is appropriately stored in the memory 170.

Thereafter, the route processor 186 of the processor 180 acquires the setting information stored in the memory 170 and determines whether or not the acquired setting information contains the traffic-jam prediction request information (Step S105).

If the route processor 186 of the processor 180 determines in Step S105 that the traffic-jam prediction request information is not contained, the traffic-jam condition recognizer 185 acquires the VICS data output from the VICS receiver 120. Then, the processor 180 generates current traffic-jam information of an area containing the current position and the destination based on the acquired VICS data. The generated current traffic-jam information is appropriately stored in the memory 170.

Then, the route processor 186 of the processor 180 acquires the current position information, the destination information, the setting information and the current traffic-jam information from the memory 170. Based on the acquired various information, it performs route search processing to search for the travel route from the current position of the vehicle to the destination, using the route-search map information and the matching data MM contained in the map information stored in the storage section 160 (Step S106).

For example, when searching for a major street of which data is stored and managed in the route-search map information, the route search processing is performed using the route-search map information. On the other hand, when searching for a minor street of which data is not stored in the route-search map information, the route from the minor street to a major street is searched for using the matching data MM. While the route search processing is performed using the matching data MM, the coordinate matching section 184 determines whether a plurality of nodes N indicate the identical point to recognize the road arrangement based on the relations between links L.

The route processor 186 detects a plurality of travel routes and selects some of the travel routes based on the acquired setting information and the current traffic-jam information to generate the travel route information about, for instance, five candidate travel routes that meet the requirements of the user. The route processor 186 estimates the required time to arrive at the destination for the respective travel routes to generate required-time information. Then, the display controller 190 controls the terminal display section 140 to display the computed travel route information about the five candidates as well as a screen for prompting the user to select any one of them. The user selects and inputs the travel route information about any one of the routes, and thus the travel route is set.

If, on the other hand, the route processor 186 determines in Step S105 that the traffic-jam prediction request information is contained, the route processor 186 acquires the time information from the timer 191 and recognizes the current date based on the acquired time information. It also acquires the current position information and the destination information stored in the memory 170 and recognizes the current position and the destination. Then, the traffic-jam condition recognizer 185 retrieves and acquires the time-series data 121 corresponding to the acquired time information and containing the current position and the destination from the traffic-jam prediction table 10 stored in the storage section 160 (Step S107).

Thereafter, the processor 180 performs the processing of Step S106. More specifically, the processor 180 generates the current traffic-jam information at the traffic-jam condition recognizer 185 and appropriately stores it in the memory 170. Then, the route processor 186 of the processor 180 acquires the current position information, the destination information and the setting information from the memory 170. Based on the acquired various information, the route processor 186 detects a plurality of travel routes and selects some of the travel routes on the basis of the acquired setting information to generate candidate travel route information about a plurality of candidate travel routes that meet the requirements of the user.

Thereafter, the traffic-jam condition recognizer 185 of the processor 180 acquires the current traffic-jam information from the memory 170 and the current time and day from the timer 191. Then, based on the acquired current traffic-jam information and the current time and day, the traffic-jam condition recognizer 185 estimates the estimated arrival time to arrive at an arbitrary spot on the respective candidate travel routes contained in the candidate travel route information generated by the route processor 186. Then, the traffic-jam condition recognizer 185 predicts the traffic-jam condition at the arbitrary spot on the respective candidate travel routes at the estimated arrival time on the basis of the time-series data 121 acquired in Step S107 and generates traffic-jam prediction information about the predicted traffic-jam condition.

Based on the current traffic-jam information and the traffic-jam prediction information, the route processor 186 of the processor 180 refines the selection of the candidate travel routes contained in the candidate travel route information to generate travel route information about, for instance, five candidate travel routes that meet the requirements of the user. The route processor 186 estimates the required time to arrive at the destination for the respective travel routes of the travel route information to generate required-time information. Then, the display controller 190 controls the terminal display section 140 to display the computed travel route information about the five candidates as well as a screen for prompting the user to select any one of them. The user selects and inputs the travel route information about any one of the routes, and thus the travel route is set.

Thereafter, the processor 180 determines whether or not there is a traffic-jam zone that is indicated by the current traffic-jam information or the traffic-jam prediction information on the travel route shown by the travel route information that is set by the route processor 186 (Step S108). If the processor 180 determines that there is no traffic-jam zone on the travel route, it acquires the matching data MM from the storage section 160. Then, the coordinate matching section 184 performs coordinate matching processing on the acquired matching data MM (Step S109) for recognizing the arrangement of roads, i.e., the connection of roads, which is stored in the memory 170. Then, under the control of the display controller 190 of the processor 180, the terminal display section 140 superimposes an icon indicating the current position of the vehicle on the basis of the current position information as well as the travel route information about the travel route selected by the user, the traffic-jam prediction information, the required-time information and the current traffic-jam information on the acquired map information, and the sound output section 150 appropriately outputs sounds for navigating the user (Step S110).

If, on the other hand, the processor 180 determines that there is a traffic-jam zone on the travel route in Step S108, the processor 180 obtains a time required for passing through the traffic-jam zone and a time required for the traffic jam to be cleared up. Specifically, based on the time-series data 12i, the processor 180 computes and obtains the traffic-jam-clearance required time that is a time required from a time at which the vehicle is estimated to arrive at the traffic-jam zone to the traffic-jam clearing time (Step S111), which is stored in the memory 170. The display controller 190 of the processor 180 controls the terminal display section 140 to display the traffic-jam-clearance required time to prompt the user to select whether the user passes through the traffic-jam zone or the user desires to avoid the traffic-jam zone and wait at a rest area until the traffic-jam is cleared up (Step S112).

Upon recognizing information indicating that the user does not desire to wait at the rest area from the user's input, the processor 180 performs the coordinate matching processing of Step S109 and the navigation processing of Step S110. Specifically, the processor 180 acquires the matching data MM from the storage section 160 and allows the coordinate matching section 184 to perform the coordinate matching processing on the acquired matching data MM. Then, the processor 180 recognizes the arrangement of roads, i.e., the connection of roads, which is stored in the memory 170. Then, under the control of the display controller 190 of the processor 180, the terminal display section 140 superimposes an icon indicating the current position of the vehicle on the basis of the current position information as well as the travel route information about the travel route selected by the user, the traffic-jam prediction information, the required-time information and the current traffic-jam information on the acquired map information, and the sound output section 150 appropriately outputs sounds for navigating the user.

When, on the other hand, the processor 180 recognizes information indicating that the user desires to wait at the rest area from the user's input in Step S112, the processor 180 performs avoiding processing to navigate to the rest area. Specifically, the traffic-jam avoiding section 187 of the processor 180 recognizes the rest-area-type table 20. Then, the processor 180 recognizes the traffic-jam level information based on the traffic-jam-clearance required time stored in the memory 170. The traffic-jam information can be preset by the user on the basis of the traffic-jam-clearance required time such that, for instance, when the traffic-jam-clearance required time is one hour or longer, the traffic-jam level is set to high; when the traffic-jam-clearance required time is thirty minutes to one hour, the traffic-jam level is set to middle; and when the traffic-jam-clearance required time is shorter than 30 minutes, the traffic-jam level is set to low. Then, rest-area-type information 21 of the corresponding traffic-jam information 22 corresponding to the traffic-jam level information (Step S113).

Next, the selected rest-area-type information 21 is displayed on the terminal display section 140 to prompt the user to select a desired type of rest area from the selected rest-area-type information 21. Once the rest-area-type information 21 is selected by the input operation of the user, the processor 180 operates the information retriever 188 to retrieve candidates for the rest area based on the selected rest-area-type information 21 (Step S114). Then, the traffic-jam avoiding section 187 selects a rest area, from the retrieved candidates, which is remote from the traffic-jam zone and located within a predetermined distance area from the travel route that is set in Step S106, the selected rest area being stored in the memory 170 (Step S115).

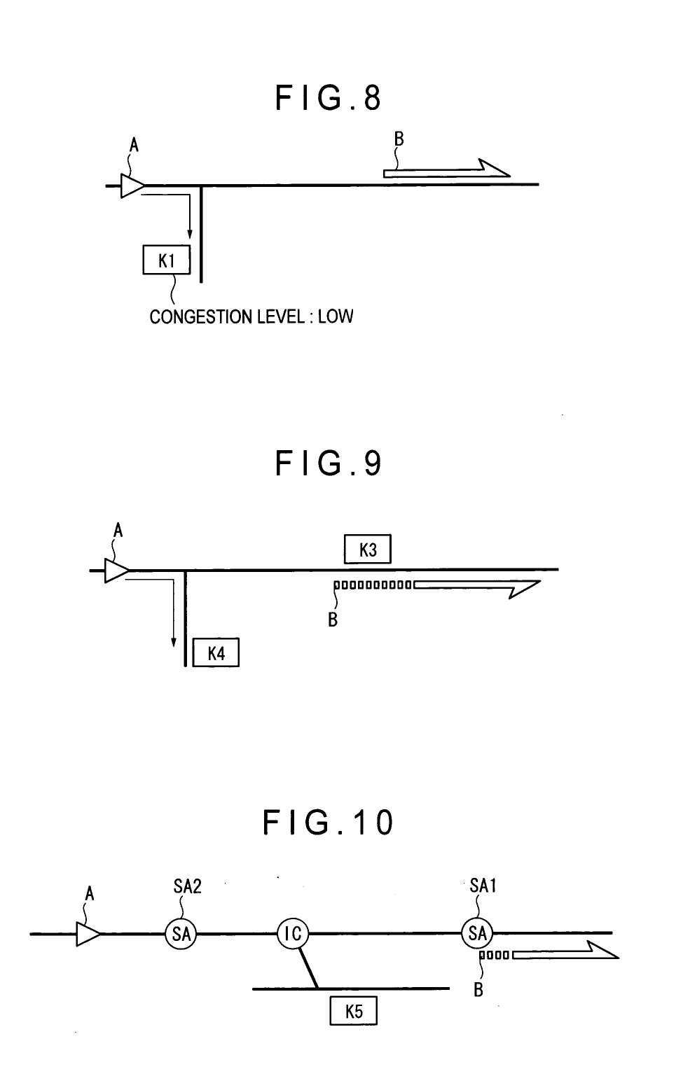

At this time, as shown in FIG. 8 for instance, when the traffic-jam avoiding section 187 predicts that the traffic-jam zone of the currently occurring traffic-jam will not likely grow further, the traffic-jam avoiding section 187 acquires candidates for rest areas located in a zone between a current position A and a tail B of the traffic jam. Then, from the candidates for the rest areas, a rest area K1 that is close to the travel route and has a low congestion level is selected.

As shown in FIG. 9, when the traffic-jam avoiding section 187 predicts from the traffic-jam prediction information that the traffic-jam will grow, the traffic-jam avoiding section 187 does not select a rest area K2 that is located in a zone contained in the grown traffic jam, but select a rest area K3 that is located in a zone between the current position

A and a tail B of a zone in which the traffic jam is predicted to arise. In this case, when there are a plurality of candidates for the rest areas, a rest area that is close to the travel route and has a low congestion level is selected.

When the vehicle travels on a highway or the like, if the traffic-jam avoiding section 187 recognizes that there is a traffic-jam zone, it recognizes congestion levels of service areas SA1 and SA2 and a nearby rest area K5. Then, when it is recognized that the service area SA1 that is right before a zone predicted to have the traffic jam shows a high congestion level, while the service area SA2 and the rest area K5 that are remote from the predicted traffic-jam zone each have a low congestion level, the traffic-jam avoiding section 187 selects the service area SA2. If the congestion level of the service area SA2 is also high, the traffic-jam avoiding section 187 selects the rest area K5. By performing the selection as described above, when the vehicle travels on the highway, the rest area can be selected so as to avoid as far as possible getting off from the highway to take a rest.

Then, the processor 180 operates the route processor 186 to search for a travel route to the rest area based on the selected rest area information to acquire travel route information (Step S116). The setting of the travel route is substantially similar to the setting of the travel route in Step S106, where the route processor 186 acquires the current position information, the rest area information, the setting information and the current traffic-jam information from the memory 170. Based on the acquired various information, the route processor 186 performs route search processing to search for the travel route from the current position of the vehicle to the rest area, using the route-search map information and the matching data MM contained in the map information stored in the storage section 160. Note that if there is a traffic-jam zone on the travel route to the rest area which is set in the route search processing, the processor 180 may control the terminal display section 140 to display an indication for prompting user to select another rest area. Alternatively, when the rest area is retrieved in Step S114, the search processing for the travel route to the rest area may be performed simultaneously with the retrieval of the rest area so that rest area information having a traffic-jam zone on a travel route to a rest area can be eliminated from the candidates of the rest areas.

The processor 180 then performs the processing of Steps S109 and S110. Specifically, the processor 180 acquires the matching data MM from the storage section 160. Then, the coordinate matching section 184 performs the coordinate matching processing on the acquired matching data MM for recognizing the arrangement of roads, or the connection of roads, which is stored in the memory 170. Then, under the control of the display controller 190 of the processor 180, the terminal display section 140 superimposes an icon indicating the current position of the vehicle on the basis of the current position information as well as the travel route information about the travel route to the rest area, the traffic-jam prediction information, the required-time information and the current traffic-jam information on the acquired map information, and the sound output section 150 appropriately outputs sounds for navigating the user.

### Advantage of First Embodiment

As described above, the navigation device 100 of the first embodiment recognizes the map information, the current traffic-jam information and the traffic-jam prediction information, and when it is predicted, based on the traffic-jam information, that the vehicle will be involved in the traffic jam during the travel on the travel route, the navigation device 100 acquires the rest area information about rest areas within a predetermined distance area from the traffic-jam zone, which is notified to the user. Accordingly, when it is predicted that the vehicle will be involved in the traffic jam, the navigation device 100 provides navigation to a rest area in advance, so that the user can avoid the traffic jam and take a rest at the rest area. Therefore, the user does not have to waste a long time by being involved in the traffic jam and does not have to travel a long distance to avoid the traffic jam, thus lowering cost required for the travel as well as assisting preferable driving.

The traffic-jam avoiding section 187 acquires rest area information corresponding to the selected rest-area-type information 21 based on the map information. Accordingly, the position of the rest area can be superimposed on the map information. Thus, the user can easily recognize the rest area information that is superimposed on the map information. Further, the traffic-jam avoiding section 187 can easily compute and acquire the travel route to the rest area and the travel distance based on the map information.

Then, the route processor 186 recognizes the rest area information acquired by the traffic-jam avoiding section 187 as a destination, and searches for a travel route from the current position to the rest area, and the display controller 190 displays the travel route to the rest area on the terminal display section 140. Thus, the user can easily recognize the travel route from the current position to the rest area. Therefore, the user can arrive at the rest area without getting lost by following the travel route.

The traffic-jam condition recognizer 185 recognizes a time at which the traffic jam is estimated to be cleared up based on the time-series data 121 to calculate the traffic-jam-clearance required time. Then, the traffic-jam avoiding section 187 recognizes the traffic-jam level based on the traffic-jam-clearance required time to select the rest-area-type information 21 having the corresponding traffic-jam information corresponding to the recognized traffic-am level. Accordingly, the rest area is selected in accordance with the time required for the traffic jam to be cleared up, thereby navigating the user to the rest area in accordance with the traffic-jam level. Further, by departing from the rest area in accordance with the time when the traffic jam is cleared up, the user can drive the vehicle comfortably without being involved in the traffic jam, so that the user can avoid situations where: the traffic jam is not cleared up yet when the user travels again to the destination from the rest area; or the user stays at the rest area too long.

The traffic-jam avoiding section 187 selects a rest area that is not congested based on the congestion level that is recognized from information about, for instance, availability of a parking area of the rest area, which is received by the VICS receiver 120 and stored in the memory 170. Thus, the user can enter the rest area smoothly without waiting for entering the parking area, waiting for seats in the rest area, or the like. Therefore, the user can enjoy taking a rest comfortably.

### Second Embodiment

Next, a second embodiment of the present invention will be described with reference to the attached drawings.

A communication navigation system of this embodiment is an example of a traffic-condition notifying system of the present invention, and so designed to navigate a mobile body (e.g. a vehicle) for the travel or drive thereof. As in the case of the first embodiment, the traffic-condition notifying system of the present invention is not necessarily designed to navigate a vehicle for the drive thereof, but may be so designed to notify traffic information regarding any type of mobile body.

The components same as those in the first embodiment are denoted respectively by the same reference symbols and will not be described any further in the present embodiment.

[Arrangement of Navigation System]

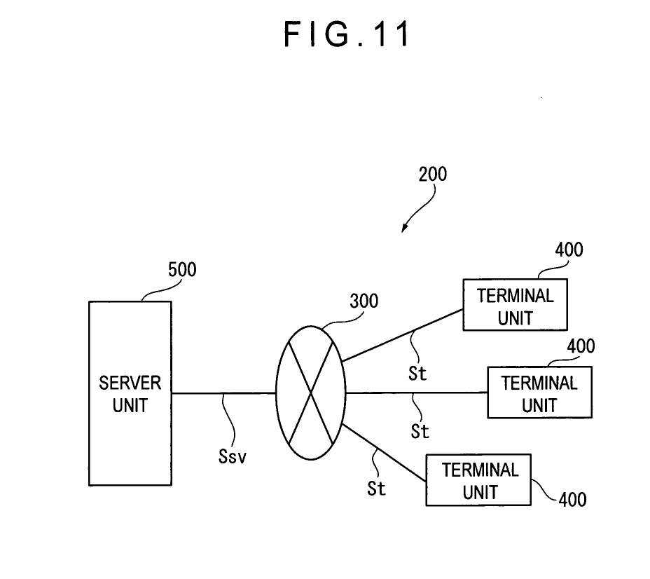

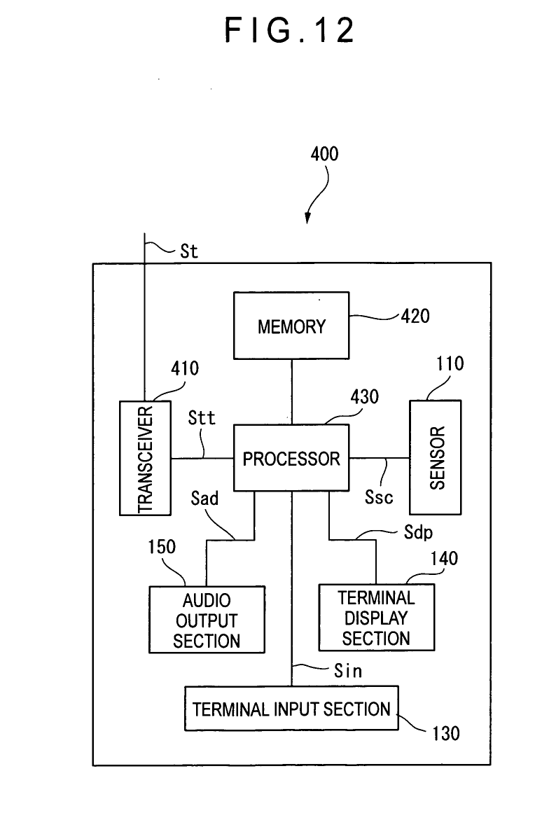

Referring to FIG. 11, the reference numeral 200 denotes the communication navigation system (traffic-condition notifying system). The navigation system 200 notifies guidance on a travel along with a travel progress of a mobile body (e.g. a vehicle). The mobile body is not limited to vehicles, but includes any type of mobile body such as aircrafts and ships. The navigation system 200 has a network 300, a terminal unit 400 that also operates as a traffic-condition notifying device, and a server unit 500.

The network 300 is connected to the terminal unit 400 and the server unit 500. The network 300 interconnects the terminal unit 400 and the server unit 500 to enable the communication therebetween. The network 300 may be Internet based on a general-purpose protocol such as TCP/IP protocol, an intranet, a LAN (Local Area Network), a communication network and a broadcasting network that have a plurality of base stations capable of communicating by way of a radio medium, or the radio medium itself that enables direct communication between the terminal unit 400 and the server unit 500. The radio medium may be any one of electric waves, light beams, acoustic waves and electromagnetic waves.

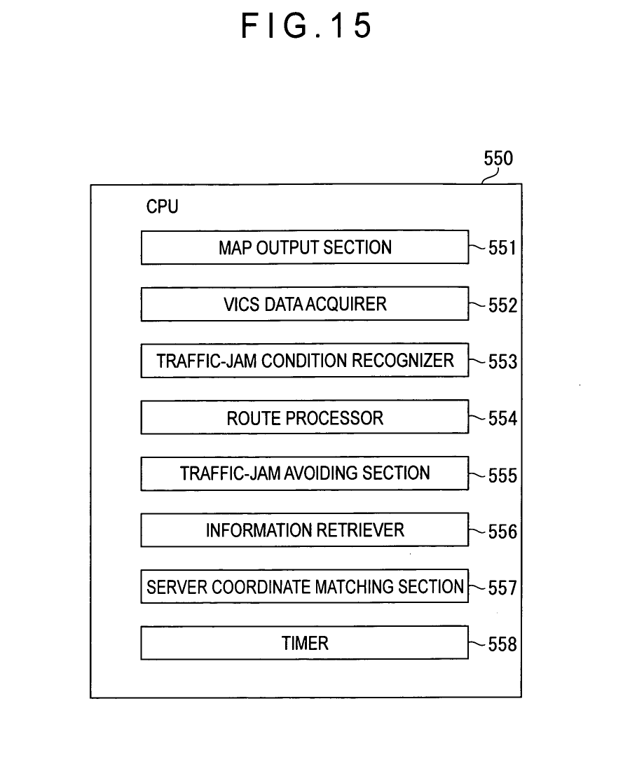

Like the navigation device 100 of the first embodiment, the terminal unit 400 may be, for example, an in-vehicle unit installed in a vehicle as a mobile body, a portable unit, a PDA (Personal Digital Assistant), a portable phone, a PHS (Personal Handyphone System) or a portable personal computer. The terminal unit 400 acquires map information delivered by the server unit 500 via the network 300. On the basis of the map information, the terminal unit 400 retrieves and displays information about a current position and a destination, a route to the destination, predetermined shops nearby, and information about services offered by the shops. As shown in FIG. 15, the terminal unit 400 includes a transceiver 410 that operates as a terminal communicator, the sensor 110, the terminal input section 130, the terminal display section 140, the sound output section 150, a memory 420, a processor 430 and so on.

The transceiver 410 is connected to the server unit 500 via the network 300, while being connected to the processor 430. The transceiver 410 can receive a terminal signal St from the server unit 500 via the network 300. When acquiring the terminal signal St, the transceiver 410 performs preset input interface processing so as to output the terminal signal St as a processing terminal signal Stt to the processor 430. The transceiver 410 can also input the processing terminal signal Stt from the processor 430. When acquiring the processing terminal signal Stt to be input, the transceiver 410 performs preset output interface processing so as to send the processing terminal signal Stt as the terminal signal St to the server unit 500 via the network 300.

The sensor 110 detects the travel progress of the vehicle, or the current position and the driving status, and outputs it as a predetermined signal Ssc to the processor 430.

The terminal input section 130 has various operation buttons and operation knobs (not shown) to be used for input operations. The operation buttons and the operation knobs are used to input, for example, the settings for the operations of the terminal unit 400. More specifically, operation buttons and the operation knobs may be used: to issue a command for executing a communication operation as communication request information for acquiring information via the network 300; to set the type of information to be acquired and acquiring criteria; to set a destination; to retrieve information; and to display the driving status (travel progress) of the vehicle. When the settings are input, the terminal input section 130 outputs a predetermined signal Sin to the processor 430 so as to apply the settings.

The terminal display section 140, under the control of the processor 430, displays a signal Sdp representing image data sent from the processor 430. The image data may be image data of the map information and the retrieval information sent from the server unit 500.

The sound output section 150, under the control of the processor 430, outputs and notifies various signals Sad as sounds from an audio section. The various signals Sad represent the sound data etc. sent from the processor 430.

The memory 420 appropriately stores various information acquired via the network 300, the settings that are input by the terminal input section 130, the rest area information about rest areas, music data, image data and the like. The memory 420 also stores various programs that run on the OS (Operating System) controlling the whole operation of the terminal unit 400. The memory 420 may include drives or drivers for readably storing data on a recording medium such as a HD (Hard Disk) or an optical disc.

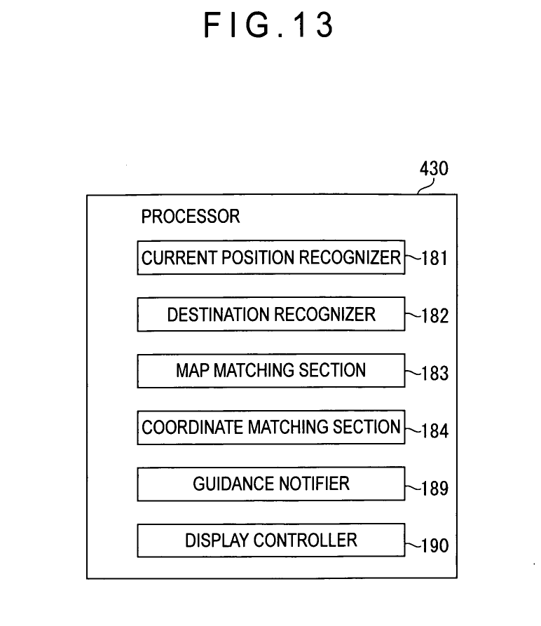

The processor 430 has various input/output ports (not shown) including a communication port connected to the transceiver 410, a GPS receiving port connected to a GPS receiver of the sensor 110, sensor ports respectively connected to various sensors of the sensor 110, a key input port connected to the terminal input section 130, a display control port connected to the terminal display section 140, a sound control port connected to the sound output section 150 and a storage port connected to the memory 420. As shown in FIG. 13, the processor 430 has various programs such as the current-position recognizer 181 (current position information acquirer), the destination recognizer 182 (destination information acquirer), the map matching section 183, the coordinate matching section 184, the guidance notifier 189, the display controller 190 and so on.

The current-position recognizer 181 recognizes the current position of the vehicle. Various information acquired by the current-position recognizer 181 is appropriately stored in the memory 420.

The destination recognizer 182 typically acquires the destination information about the destination set by the input operation at the terminal input section 130 and recognizes the position of the destination. Such destination information recognized by the destination recognizer 182 is appropriately stored in the memory 420.

The map matching section 183 performs the map matching processing for displaying the current position recognized by the current-position recognizer 181 based on the map information acquired from the server unit 500.

The coordinate matching section 184 performs the coordinate matching processing for determining whether or not point information about nodes N contained in the matching data MM of the map information acquired from the server unit 500 indicate an identical point.

The guidance notifier 189 provides guidance stored in the memory 420 on the basis of travel route information and feature guidance information acquired in advance according to the driving status. The guidance is related to the travel of the vehicle, which may be the contents for assisting the drive of the vehicle.

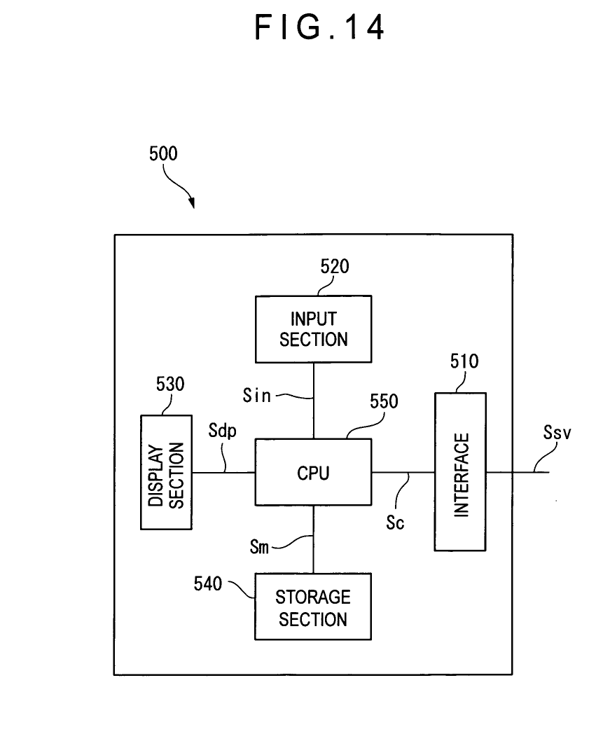

The server unit 500 can transmit/receive information to/from the terminal unit 400 via the network 300. The server unit 500 is capable of acquiring various information from other server units (not shown) of various government offices such as Meteorological Agency and National Police Agency, private organizations, VICS and business enterprises via the network 300. The information to be acquired may be travel information for the vehicle, i.e., various travel related information used during the travel of the vehicle such as weather information, VICS data including traffic jam, traffic accidents, constructions, traffic controls, and shop information about various shops including gasoline stations and restaurants etc. As shown in FIG. 14, the server unit 500 includes an interface 510, an input section 520, a display section 530, a storage section 540, a CPU (Central Processing Unit) 550 and so on.

The interface 510 performs preset input interface processing over a server signal SSv input via the network 300 so as to output the server signal SSv as a processing server signal Sc to the CPU 550. When the processing server signal Sc to be sent to the terminal unit 400 is input in the interface 510 from the CPU 550, the interface 510 performs preset output interface processing over the input processing server signal Sc so as to output the processing server signal Sc as a server signal SSv to the terminal unit 400 via the network 300. Note that the server signal SSv can be appropriately output only to a predetermined terminal unit 400 on the basis of the information described in the processing server signal Sc.

Like the terminal input section 130, the input section 520, which may be a keyboard, a mouse or the like, has various operation buttons and operation knobs (not shown) to be used for input operations. The operation buttons and the operation knobs are used: to input the settings for operations of the server unit 500; to set information to be stored in the storage section 540; and to update the information stored in the storage section 540. When the settings are input, the input section 520 outputs a signal Sin corresponding to the setting to the CPU 550 so as to apply the settings. In place of the input operation using the operation buttons and the operation knobs, input operation using a touch panel arranged on the display section 530, sound input operation and the like may be employed for inputting various settings.

The display section 530, just like the terminal display section 140, displays a signal Sdp representing an image data sent from the CPU 550 under the control of the CPU 550. The image data may be those acquired from the storage section 540 and those acquired from external server units via the network 300.

The storage section 540 readably stores various information received from the terminal unit 400 and external server units such as the map information as shown in FIGS. 2 and 3, the traffic-jam prediction table 10 as shown in FIG. 4, and the rest-area-type table 20 as shown in FIG. 5. More specifically, although not shown, the storage section 540 has a various information storage area for storing various information, a map information storage area that operates as a map information storage section for storing map information, a traffic-jam prediction table storage area that operates as a statistical traffic-information storage section for storing traffic-jam prediction table 10, and a rest area storage area for storing rest-area-type table 20.

While the storage section 540 has the above-described four storage areas in the above description, the storage section 540 may not have any of the above-described storage areas, or may have additional storage areas. The storage section 540 may include drives or drivers for readably storing data on recording medium such as a HD (Hard Disk), a DVD (Digital Versatile Disc), an optical disc and a memory card. Information to be stored may include, for example, information input by the input operation at the input section 520, and contents of the information stored with the input operation can be appropriately updated. The storage section 540 also stores information such as various programs that run on an OS (Operating System) controlling the whole operation of the server unit 500 and the navigation system 200.

The storage section 540 typically stores the retrieval information for acquiring information of a predetermined point in the map information. More specifically, the retrieval information provided upon the retrieval request from the terminal unit 400 includes various information about contents and guidance such as names of states, cities, regions and points, which are units used to gradually divide the map information into smaller areas, as well as various information about shops as points. The retrieval information is structured in a tree structure table so that plural pieces of item information are hierarchically associated with each other.

The storage section 540 stores personal information about users who use the navigation system 200 with the terminal unit 400. The personal information may include a name and an address, a user ID number and a password assigned to each user, a type of the terminal unit 400 for the use of the navigation system 200, and an address number of the terminal unit 400 used for transmitting/receiving information to/from the terminal unit 400. Furthermore, the storage section 540 stores various information used for performing the navigation processing in a manner readable by the CPU 550.

As shown in FIG. 15, the CPU 550 has various programs stored in the storage section 540 such as a map output section 551, a VICS data acquirer 552 that operates as a traffic-information acquirer, a traffic-jam condition recognizer 553 that operates as a traffic information acquirer, a statistical-traffic-information acquirer, a traffic-condition transition recognizer, a traffic-jam-clearance required time recognizer and a traffic-jam recognizer, a route processor 554 that operates as a route searcher, a traffic-jam avoiding section 555 that operates as a stop-off information acquirer, an information retriever 556, a server coordinate matching section 557, a timer 558, and so on.

The map output section 551 responds to the input of the processing server signal Sc to refer to the information requesting a delivery of the information about the map information contained in the processing server signal Sc, and retrieves the requested information from the map information stored in the storage section 540, e.g., the display data VM and matching data MM corresponding to a predetermined area to read it out as the memory signal Sm. The map output section 551 appropriately converts the read memory signal Sm into a processing server signal Sc, outputs the processing server signal Sc to predetermined or all terminal units 400 via the interface 510 and the network 300 on the basis of the processing server signal Sc, and delivers the requested information contained in the map information.

The VICS data acquirer 552, just like the VICS receiver 120 of the first embodiment, responds to the input of the processing server signal Sc and refers to the information about the request for the route search contained in the processing server signal Sc so as to acquire the VICS data from the VICS (not shown).

The traffic-jam condition recognizer 553 responds to the input of the processing server signal Sc and refers to the information about the request for the route search contained in the processing server signal Sc so as to generate current traffic-jam information as the memory signal Sm based on the VICS data acquired by the VICS data acquirer 552. Also, the traffic-jam condition recognizer 553, just like the traffic-jam condition recognizer 185 of the first embodiment, responds to the input of the processing server signal Sc and refers to the information about the request for the travel route search based on the traffic-jam information and the traffic-jam prediction contained in the processing server signal Sc so as to generate traffic-jam prediction information as the memory signal Sm. Then, the traffic-jam condition recognizer 553 appropriately converts the generated memory signal Sm into a processing server signal Sc, outputs the processing server signal Sc to a predetermined or all terminal units 400 via the interface 510 and the network 300 on the basis of the processing server signal Sc, and notifies a current traffic-jam status and a predicted traffic jam that might arise before arriving at the destination.

Additionally, the traffic-jam condition recognizer 553 obtains an estimated arrival time as an estimated time to arrive at an arbitrary spot on the route to the destination. For instance, the traffic-jam condition recognizer 553 obtains an estimated arrival time as an estimated time to arrive at an arbitrary spot on the route to the destination. Then, based on the obtained estimated arrival time, a preset scheduled time, the time-series and data 121, the traffic-jam condition recognizer 553 generates traffic-jam prediction information about predictions of the traffic jam that may arise at the arbitrary spot before arriving at the destination or at the preset scheduled time.

Further, the traffic-jam condition recognizer 553 acquires traffic-jam clearing time, which is time required for the traffic jam that is currently present or traffic jam that is predicted to arise to be cleared up. Specifically, based on the time-series data 121 of the traffic-jam prediction table 10, the traffic-jam condition recognizer 553 obtains a traffic-jam clearing time showing a time at which the traffic jam is estimated to be cleared up.

The route processor 554, just like the route processor 186 of the first embodiment, responds to the input of the processing server signal Sc and refers to the information about the request for the route search contained in the processing server signal Sc so as to generate travel route information and required-time information as the memory signal Sm. Then, the route processor 554 appropriately converts the generated memory signal Sme into a processing server signal Sc, outputs the processing server signal Sc to a predetermined or all terminal units 400 via the interface 510 and the network 300 on the basis of the processing server signal Sc, and notifies the travel route and the required time.

The traffic-jam avoiding section 555 estimates an arrival position of the vehicle at a predetermined time based on the speed information of the vehicle. Then, when the traffic-jam avoiding section 555 predicts that the vehicle arrives at the traffic-jam zone contained in the current traffic-jam information and the traffic-jam prediction information recognized by the traffic-jam condition recognizer 185, the traffic-jam avoiding section 555 performs avoiding processing for navigating the vehicle to a rest area that is remote from the traffic-jam zone. Then, based on the rest-area-type information 21 contained in the input processing server signal Sc, the rest area information is selected.

The information retriever 556, just like the information retriever 188 of the first embodiment, responds to the input of the processing server signal Sc and refers to the information about the retrieval request for the retrieval information contained in the processing server signal Sc so as to hierarchically retrieve the retrieval information stored in the storage section 540 typically on the basis of item information and read it as the memory signal Sm. Then, the information retriever 556 appropriately converts the generated memory signal Sm into a processing server signal Sc, outputs the processing server signal Sc to a predetermined or all terminal units 400 via the interface 510 and the network 300 on the basis of the processing server signal Sc, and delivers the retrieval information.

The server coordinate matching section 557, just like the above-described coordinate matching section 184 of the terminal unit 400, performs the coordinate matching processing for determining whether or not point information about nodes N contained in the matching data MM of the map information indicate an identical point.

The timer 558 recognizes the current time typically based on the pulse of an internal clock. Then, the timer 558 appropriately outputs time information about the recognized current time.

The CPU 550 responds to the signal Sin input from the input section 520 by the input operation at the input section 520, and appropriately performs computation based on the contents corresponding to the input operation to appropriately generate a signal Sdp. Then the CPU 550 appropriately outputs the generated various signals to the display section 530, the interface 510 and the storage section 540 and operates them so as to execute the input contents.

[Operation of Navigation System]

Now, the operation of the navigation system 200 will be described with reference to the attached drawings. The processing that is the same as those of the first embodiment will be described only briefly.

(Search Processing for Travel Route)

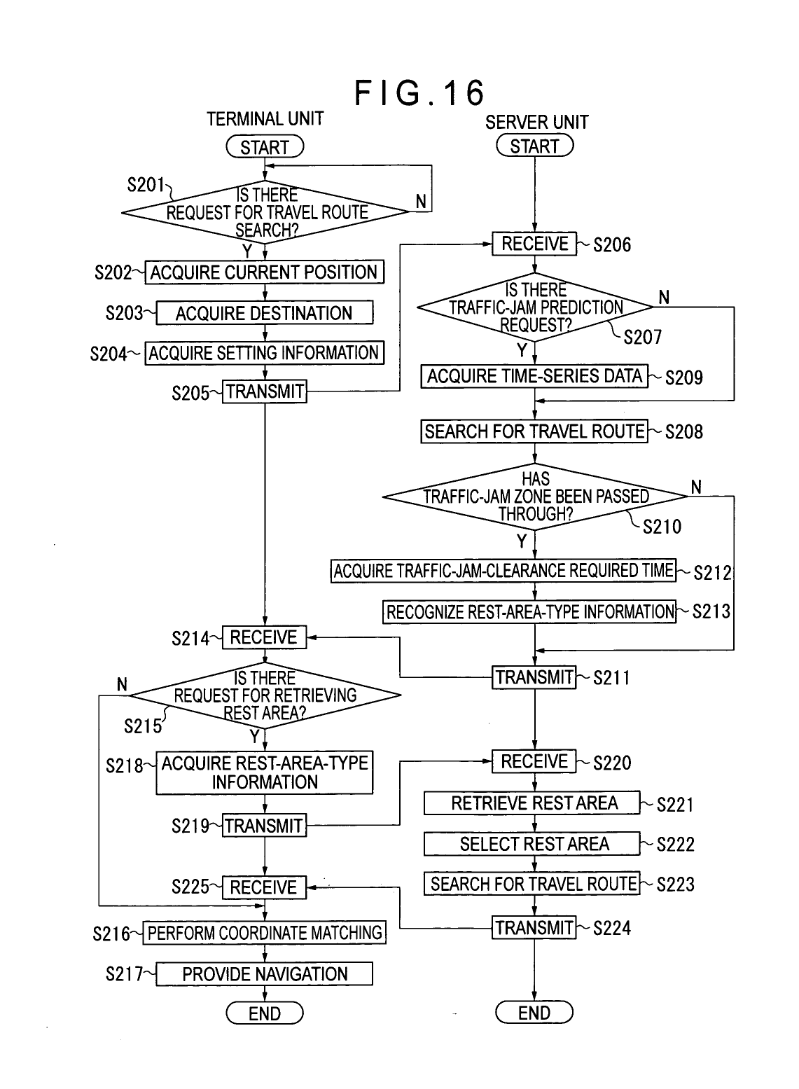

Now, the operation of the navigation system 200 will be described referring to FIG. 16.

Firstly as shown in FIG. 16, the user operates the terminal input section 130 to set a command for search processing for a travel route. When the processor 430 recognizes the set command for the search processing for the travel route (Step S201), the processor 430 operates the terminal display section 140 to display a screen for prompting the user to set various information necessary for travel route search such as the destination, the setting information about necessity of traffic-jam prediction.

When the processor 430 recognizes the various information necessary for the travel route search, the current-position recognizer 181 acquires the current position information about the current position (Step S202) and the destination recognizer 182 recognizes the destination information about the set destination (Step S203). The processor 430 also acquires the setting information about the settings that have been input (Step S204). The acquired current position information, the destination information and the setting information are appropriately stored in the memory 420.

Thereafter, the processor 430 controls the transceiver 410 to transmit the current position information, the destination information and the setting information stored in the memory 420 as well as a signal requesting the travel route search to the server unit 500. When transmitting the various information, the transceiver 410 also transmits the terminal-specific information for identifying the terminal unit 400 (Step S205).

When the server unit 500 receives the various information transmitted from the terminal unit 400 (Step S206), the route processor 554 of the CPU 550 determines whether or not the received setting information contains traffic-jam prediction request information (Step S207).

If the route processor 554 of the CPU 550 determines in Step S207 that the traffic-jam prediction request information is not contained, the VICS data acquirer 552 acquires the VICS data. Then, the traffic-jam condition recognizer 553 of the CPU 550 generates current traffic-jam information of an area containing the current position and the destination based on the acquired VICS data. Thereafter, based on the current position information, the destination information, the setting information and the current traffic-jam information, the route processor 554 of the CPU 550 executes route search processing to search for the travel route from the current position of the vehicle to the destination (Step S208).

If, on the other hand, the route processor 554 determines in Step S207 that the traffic-jam prediction request information is contained, the route processor 554 acquires the time information from the timer 558 and recognizes the current date based on the acquired time information. Then, the traffic-jam condition recognizer 553 of the CPU 550 retrieves and acquires the time-series data 121 corresponding to the acquired time information and containing the current position and the destination from the traffic-jam prediction table 10 stored in the storage section 540 (Step S209).

Thereafter, the CPU 550 performs the processing of Step S208. More specifically, the traffic-jam condition recognizer 553 of the CPU 550 generates current traffic-jam information. Based on the current position information, the destination information, the setting information and the current traffic-jam information, the route processor 554 of the CPU 550 detects a plurality of travel routes and selects some of the travel routes on the basis of the acquired setting information to generate candidate travel route information about a plurality of candidate travel routes that meet the requirements of the user. Then, the traffic-jam condition recognizer 553 of the CPU 550 acquires the current time and day from the timer 558. Then, based on the current traffic-jam information and the current time and day, the traffic-jam condition recognizer 553 estimates the estimated arrival time to arrive at an arbitrary spot on the respective candidate travel routes contained in the candidate travel route information generated by the route processor 554. Then, the traffic-jam condition recognizer 553 predicts the traffic-jam condition at the arbitrary spot on the respective candidate travel routes at the estimated arrival time on the basis of the time-series data 121 acquired in Step S410 and generates traffic-jam prediction information about the predicted traffic-jam condition.

Based on the traffic-jam information and the traffic-jam prediction information, the route processor 554 of the CPU 550 further refined the selection of the candidate travel routes contained in the candidate travel route information to generate travel route information about, for instance, five candidate travel routes that meet the requirements of the user. Then, the route processor 186 generates required-time information for the respective travel routes contained in the travel route information.

Thereafter, the server unit 500 determines whether or not there is a traffic-jam zone in the set travel route information (Step S210). Specifically, the travel route information acquired in Step S208, the current traffic-jam information recognized by the traffic-jam condition recognizer 553 and the traffic-jam prediction information are compared to determine whether or not there is a traffic-jam zone indicated by the current traffic-jam information and the traffic-jam prediction information on the travel routes.

When it is determined that there is no traffic-jam zone on the travel routes, the server unit 500 controls the interface 510 on the basis of the terminal-specific information received in Step S406 and appropriately transmits the travel route information, the traffic-jam prediction information, the required-time information and the current traffic-jam information obtained as a result of the route search processing to the predetermined terminal unit 400 together with map information (Step S211). It may acquire the matching data MM in advance on the basis of the current position information. The map information to be transmitted needs to include only the matching mesh information MMx of the matching data MM that contains the nodes N and the links L for the roads of the travel routes, the display mesh information VMx of the display data VM for other areas, the name information VMxA and the background information VMxC in the area corresponding to the matching mesh information MMx.

On the other hand, in Step S210, when it is determined that there are traffic-jam zones on the travel routes, the CPU 550 acquires traffic-jam-clearance required time information for these traffic-jam zones (Step S212). Specifically, the traffic-jam avoiding section 555 reads the time-series data 12i from the traffic-jam prediction table 10 and recognizes changes of the traffic jam over time to estimate time required for the traffic-jam to be cleared up. Then, based on the estimated traffic-jam-clearance required time, traffic-jam level information about the traffic-jam levels for the traffic-jam zones. As in the first embodiment, the traffic-jam level is so set that a traffic-jam zone with a long traffic-jam-clearance required time has a high traffic-jam level, and the traffic-jam zone with shorter traffic-jam-clearance required time has lower traffic-jam level is set.

Next, the CPU 550 reads the rest-area-type table 20 to acquire the rest-area-type information 21 that corresponds to the set traffic-jam level information (Step S213). Here, plural pieces of the rest-area-type information 21 may be acquired. For instance, the traffic-jam avoiding section 555 sets the traffic-jam level information to be high for the traffic-jam zone with the traffic-jam-clearance required time being one hour or longer. Then, the traffic-jam avoiding section 555 acquires, from the rest-area-type table 20 as shown in FIG. 4, the rest-area-type information 21 that corresponds to the corresponding traffic-jam information for the high traffic-jam level, e.g., “parking area”, “park”, “restaurant”, “shopping mall”, “amusement park” and “tourist site”.

Thereafter, the server unit 500 performs the processing of Step S211. Specifically, the server unit 500 controls the interface 510 on the basis of the terminal-specific information received in Step S406 and appropriately transmits the travel route information, the traffic-jam prediction information, the required-time information and the current traffic-jam information obtained as a result of the route search processing to the predetermined terminal unit 400 together with map information.

Then, after the processor 430 of the terminal unit 400 receives various information (Step S214), if the various information contains information for selecting the rest-area-type information 21, the processor 430 operate the terminal display section 140 to display the rest-area-type information 21 to prompt the user to select the rest-area-type information 21 (Step S215). When the processor 430 recognizes information indicating that the navigation to a rest area is not desired or information indicating that the rest-area-type information 21 is not selected, or does not receive information for selecting the rest-area-type information 21 in Step S214, the processor 430 does not perform navigation processing to the rest area. Then, the processor 430 performs the coordinate matching processing on the received matching data MM for recognizing the arrangement of roads, or the connection of roads, which is stored in the memory 420 (Step S216). Then, under the control of the display controller 190 of the processor 430, the terminal display section 140 superimposes an icon indicating the current position of the vehicle on the basis of the current-position information as well as the travel route information about the travel route to the rest area, the traffic-jam prediction information, the required-time information and the current traffic-jam information on the received map information, and the sound output section 150 appropriately outputs sounds for navigating the user (Step S217).

On the other hand, when the processor 430 acquires the rest-area-type information 21 selected by the user's input in Step S215 (Step S218), the processor 430 transmits the rest-area-type information 21 to the server unit 500 with the terminal specific information (Step S219).

When the server unit 500 receives the various information transmitted from the terminal unit 400 (Step S220), the traffic-jam avoiding section 555 of the CPU 550 recognizes the rest-area-type information 21 selected according to the received setting information. Then, traffic-jam avoiding section 555 operates the information retriever 556 to retrieve rest area information based on the rest-area-type information 21 (Step S221). The traffic-jam avoiding section 187 selects a rest area, from the retrieved rest areas, which is remote from the traffic-jam zone and located within a predetermined distance area from the travel route (Step S222). The traffic-jam avoiding section 555 selects the rest area referring to the traffic-jam zone on the travel route and the congestion level information of the rest area, as in the first embodiment.

Thereafter, based on the rest area information selected by the traffic-jam avoiding section 555, the route processor 554 searches for the travel route from the current position of the vehicle to the rest area to acquire the travel route information (Step S223). Then, the server unit 500 transmits the travel route information to a predetermined terminal unit 400 based on the terminal specific information (Step S224).

The terminal unit 400, when receiving the travel route information transmitted from the server unit 500 (Step S225), performs processing of Step S216 and Step S217. Specifically, the terminal unit 400 performs the coordinate matching processing on the received matching data MM for recognizing the arrangement of roads, or the connection of roads, which is stored in the memory 420. Then, under the control of the display controller 190 of the processor 430, the terminal display section 140 superimposes an icon indicating the current position of the vehicle on the basis of the current-position information as well as the travel route information about the travel route to the rest area, the traffic-jam prediction information, the required-time information and the current traffic-jam information on the received map information, and the sound output section 150 appropriately outputs sounds for navigating the user.

### Advantage of Second Embodiment

As described above, in the second embodiment, the server unit 500, upon recognizing request information for requesting traffic-jam avoiding processing from the terminal unit 400, selects a rest area that is remote from the travel route and transmits a travel route to the rest area to the terminal unit 400, so that the display controller 190 of the terminal unit 400 controls the terminal display section 140 to superimpose the travel route onto the map information for navigation, as in the first embodiment. Thus, when it is predicted that the vehicle will be involved in a traffic jam, the user can avoid the traffic-jam and take a rest at the rest area. Therefore, the user does not have to waste a time by being involved in the traffic jam and does not have to travel a long distance to avoid the traffic jam, thus lowering cost required for the travel as well as notifying a comfortable travel route. By avoiding the traffic jam as described above, the user can take a rest at the rest area until the traffic-jam is cleared up, and can travel comfortably on the travel route with the traffic-jam having already been cleared up after the rest.

According to the second embodiment, the server unit 500 stores the map information and the traffic-jam prediction table 10 used for the traffic-jam prediction, the traffic-jam prediction table 10 having relatively large data volume. Accordingly, the arrangement of the terminal unit 400 can be simplified, and only by, for instance, updating the map information and traffic-jam prediction table 10 by the server unit 500, the updated information can be shared also in the terminal unit 400. In addition, since maintainability and operability of the navigation system 200 can be enhanced, while the latest information can be acquired appropriately by the terminal unit 400, preferable navigation based on the latest information can be obtained, providing enhanced user-friendliness.

The server unit 500 storing the map information and the traffic-jam prediction table 10 searches for the travel routes and selects rest area information to distribute them to the terminal unit 400. With this arrangement, the processing load of the terminal units 400 can be reduced. In other words, the terminal unit 400 is not required to have a large processing capacity, so that the arrangement of the terminal unit 400 may be simplified, allowing the use in a portable phone etc. Thus, the size and the cost thereof can be reduced, and thereby easily promoting the wide use thereof.

### Modification of Embodiment

The present invention is not limited to the above specific embodiments, but includes modifications as long as the object of the present invention can be attained.

Although the corresponding traffic-jam information 22 of the rest-area-type table 20 contains information about traffic-jam levels of traffic-jam zones in the first and second embodiments, the arrangement is not limited thereto. For instance, the corresponding traffic-jam information 22 may contain a specific numeral value indicating to which traffic-jam-clearance required time the rest-area-type information 21 corresponds.

Although the traffic-jam avoiding section 187, 555 selects, based on the traffic-jam clearance-required time required for the traffic jam to be cleared up, a rest area that is located in a place where the user can return to the travel route to the destination by the time the traffic-jam is cleared up, the arrangement is not limited thereto. As an example, the traffic-jam avoiding section may select a rest area such that, by comparing a total time including a travel time to a rest area and a rest time at the rest area with traffic-jam passing through time required for passing through the traffic-jam at a predetermined time, the total time becomes equal or shorter. Specifically, suppose that, for instance, it takes three hours to pass through a predicted traffic-jam zone without stopping off the rest area, while it takes four hours to pass through the predicted traffic-jam zone after stopping off the rest area, including the travel time to the rest area and the rest time. In such case, if one hour as the time difference is within an allowable time range that has been input by the user in advance, the traffic-jam avoiding section selects the rest area, otherwise it does not select the rest area. With such arrangement, for instance, by comparing the case in which the user goes to the destination after stopping off the rest area with the case in which the user directly passes through the traffic jam to select the rest area causing no great time difference, the user can use time more effectively.

As another example, the traffic-jam avoiding section may select a rest area such that, by comparing a total time including a travel time to a rest area, a rest time at the rest area and a travel time from the rest area to the destination with a direct travel time from the current position to the destination, the total time becomes equal or shorter. As still another example, the traffic-jam avoiding section may select a rest area such that, by comparing a total time including a travel time to a rest area, a rest time at the rest area and a return travel time from the rest area to the original travel route with the direct travel time from the current position to the destination, the total time in the case with stopping off the rest area becomes equal or shorter. Such arrangement allows the user to select the rest area to take a rest, while allowing the user to arrive at the destination in a time equal to or shorter than the time required to arrive at the destination after being involved by the traffic-jam, so that the user can use the time effectively. Note that, being equal to or shorter than the direct travel time to the destination indicates that, as described above, the time difference between an arrival time at the destination after stopping off the rest area and an arrival time at the destination after directly passing through the traffic-jam is within the allowable time range that has been input by the user in advance.

As further example, the traffic-jam avoiding section may select a rest area such that, by recognizing the change of the traffic-jam over time by the time-series data 12i to obtain a traffic-jam reducing time which is an estimated time required for the traffic jam to be reduced, a total time including a travel time to a rest area, a rest time at the rest area and a return travel time from the rest area to the original travel route becomes substantially equal to the traffic-jam reducing time. With the arrangement, the user can use the time effectively at the rest area, while traveling without being involved by the traffic-jam. As further example, the traffic-jam avoiding section may select a rest area when, by comparing a time required for directly passing through the traffic-jam zone with a time required for passing through the traffic-jam zone after stopping off the rest area, the time required for passing through the traffic-jam zone is shorter.

As further example, the traffic-jam avoiding section may select a rest area such that, by comparing a total time including a travel time to a rest area and a return travel rime from the rest area to the original travel route with the traffic-jam passing time, the total time in the case with stopping off the rest area becomes equal to or shorter than the traffic-jam passing time. As further example, the traffic-jam avoiding section may select a rest area such that, by comparing a total time including a travel time to a rest area and a travel time of a reset travel route from the rest area to the destination with the travel time from the current position to the destination, the total time in the case with stopping off the rest area becomes shorter. In such case, the time required for travel can be shortened by comparing only the travel times in the vehicle, the user can travel comfortably while using the time effectively. In addition, since the user is free from time constraints, he/she can leisurely take a rest at the rest area.

Although the processor 180, 550 operates the information retriever 188, 556 to retrieve rest areas based on the rest-area-type information 21 recognized though the user's input and the traffic-jam avoiding section 187, 555 automatically selects a rest area from the retrieved rest areas in the first and second embodiments, the arrangement is not limited thereto. As an example, the traffic-jam avoiding section operates the display controller to display on the terminal display section the rest areas retrieved by the information retriever in order to prompt the user to select a rest area. With the arrangement in which the rest area can be selected by the user's input, the user can select a rest area that suits the user's preference from a plurality of candidates.

As another example, the processor may be provided with a preference determiner that stores, for instance, destination information input by the user to determine preference of the user from facilities and shops that the user often visits. Further, the traffic-jam avoiding section may determine the preference of the user from the stored destination information to select the rest area. In such case, without necessity of the user's selection of a rest area and input operation, the traffic-jam avoiding section can determine the user's preference and select a rest area that is desired by the user. As still another example the rest-area-type information may contain priority information about priority which has been set by the user in advance. For instance, by setting priority information of “restaurants” to be high in advance by the user's input, when “restaurant” and “amusement park” has the same traffic-jam corresponding information, the traffic-jam avoiding section selects the “restaurant” having high priority. By thus setting the priority information in advance, without the necessity of the user's selection of the rest-area-type information in the traffic-jam avoiding processing, a desired rest area can be automatically selected.

The navigation device 100 or the terminal unit 400 may be removably installed in the vehicle. With such arrangement, after arriving at the rest area using the arrangement of the embodiments described above, the user can remove the navigation device 100 or the terminal unit 400 to bring it with him/her. Then, when the traffic-jam condition recognizer 185 recognizes that the traffic-jam is cleared up, the clearance of the traffic-jam may be displayed, for instance, on the terminal display section and notified to the user. With the arrangement, the clearance of the traffic-jam can be notified to the user promptly.

The arrangement described above may include a departure-time controller that also serves as: an estimated-departure-time computing section that computes an estimated departure time for the vehicle to depart from the rest area on the basis of a travel time from the travel route, which is computed and set by the route processor based on the destination information, to the rest area and the traffic-jam-clearance required time that is computed by the traffic-jam condition recognizer; a notifying information generator; and a departure-standby status recognizer. The departure time controller generates departure notification information for prompting the user to start the vehicle based on the estimated departure time and the current time recognized by the timer.

The departure time controller recognizes the current position of the vehicle and a position of the navigation device or the terminal unit that has been removed from the vehicle and brought by the user to estimate a travel time from the navigation device or the terminal unit to the vehicle. The estimation may be made by settings that has been input in advance depending on a distance from the vehicle, or by acquiring a distance from the navigation device or the terminal unit to the vehicle based on the map information to compute the travel time therebetween. The departure-time controller then set a timing to notify departure information based on the travel distance from the navigation device or the terminal unit to the vehicle and notifies a departure time by displaying it on the terminal display section.

With such arrangement, in a case where the user is away from the vehicle in the rest area and cannot start the vehicle right away, the departure-time information can be notified earlier. Therefore, the user can return to the vehicle based on the notified departure time and thus can return to the travel route in accordance with the traffic-jam clearance required time.

Although the arrangement in which the navigation device or the terminal unit is removably installed in the vehicle has been described above, the arrangement is not limited thereto. For instance, the notifier such as the terminal display section or the sound output section may be removably installed in the navigation system or the terminal unit. With such arrangement, since only the notifier such as the sound output section can be removed from the navigation device or the terminal unit, portability thereof can be enhanced. As another example, the navigation device or the server unit may include an arrangement in which identification information of a portable communication device such as an e-mail address of a portable phone or an e-mail address of a portable personal computer is registered so that, when the traffic condition recognizer recognizes that the traffic-jam is cleared up, information notifying the clearance of the traffic-jam is transmitted. With such arrangement, the user can recognize the clearance of the traffic-jam easily. In addition, by employing the portable phone or the like that has good portability as the portable communication device, removing operation of the navigation device or the terminal unit from the vehicle can be saved. In the arrangement such as the second embodiment where the information indicating the clearance of the traffic jam is transmitted in the navigation device using the server unit, when, for instance, the vehicle is parked in a parking area and the terminal unit is turned off, the information can be received by the portable communication device such as the portable phone.

Although the traffic-jam avoiding section 187 recognizes the traffic-jam level based on the traffic-jam-clearance required time calculated by the traffic-jam condition recognizer 185 to select the rest-area-type information 21 having the corresponding traffic-jam information corresponding to the recognized traffic-jam level in the first and second embodiment, the arrangement is not limited thereto. For instance, the traffic-jam condition recognizer 185 may recognize a traffic-jam distance of a traffic-jam zone to obtain the traffic-jam level by the traffic-jam distance.

Although the traffic-jam avoiding section 187 recognizes the congestion level of the rest area to select a rest area with low congestion level in the first and second embodiments, the arrangement is not limited thereto. For instance, in addition to the congestion level, scales of rest areas or the number of facilities of the rest areas may be referred to in selecting a rest area. With the arrangement, navigation to a more comfortable rest area can be provided.

Although the congestion level is received by the VICS receiver 120 in the first embodiment, the arrangement is not limited thereto. For instance, information regarding the rest area such as the congestion level may be received via a network. In such case, shops and tourist sites as the rest area may distribute information such as availability of their parking areas or tourist sites, so that the distributed information may be acquired.

The specific structures and the operating procedures for the present invention may be appropriately modified as long as the scope of the present invention can be attained.

### Effect of Embodiment

The navigation device 100 recognizes the map information, the current traffic-jam information and the traffic-jam prediction information, and when it is predicted, based on the traffic-jam information, that the vehicle will be involved in the traffic jam during the travel on the travel route, the navigation device 100 acquires the rest area information about rest areas within a predetermined distance area from the traffic-jam zone, which is notified to the user. Thus, when it is predicted that the vehicle will be involved in the traffic jam, the navigation device 100 notifies guidance to the rest area in advance, so that the user can avoid the traffic jam and take a rest at the rest area. Therefore, the user does not have to waste a long time by being involved in the traffic jam and does not have to travel a long distance to avoid the traffic jam, thus lowering cost required for the travel as well as assisting the preferable driving.

### INDUSTRIAL APPLICABILITY

The present invention is applicable to a traffic-condition notifying device for notifying traffic conditions for a mobile body, its system, its method, and a program for executing the method.

1: A traffic-condition notifying device, comprising:
a map information acquirer for acquiring map information;
a current position recognizer for acquiring current position information about a current position of a mobile body;
a destination recognizer for recognizing destination information about a destination;
a route searcher for searching for a travel route of the mobile body from the current position to the destination;
a traffic-information recognizer for recognizing traffic information about a traffic condition;
a statistical-traffic-information acquirer for acquiring statistical traffic information that is obtained by statistically processing traffic conditions in the past based on time factors;
a traffic-jam-condition change recognizer for recognizing a change over time in the traffic condition of travel route of the mobile body based on the statistical traffic information;
an arrival position recognizer for recognizing a predicted arrival position of the mobile body at a predetermined time;
a predicted traffic-jam position recognizer for recognizing a predicted traffic-jam position at a predetermined time that is estimated based on the change over time in the traffic condition;
a stop-off information acquirer for acquiring, when determining that the mobile body arrives at the predicted traffic-jam position based on the predicted arrival position of the mobile body and the predicted traffic-jam position, stop-off information regarding a stop-off point located in a predetermined distance area from the travel route; and
a notification controller for controlling a notifier to notify the stop-off information.

2: The traffic-condition notifying device according to claim 1, wherein the stop-off information acquirer acquires the stop-off information based on the map information.

3: The traffic-condition notifying device according to claim 1, wherein the route searcher searches for a travel route to the stop-off point with the stop-off information being a destination and operates the notification controller to perform notification control.

4: The traffic-condition notifying device according to claim 1 further comprising:
a traffic-jam-passing-time recognizer for recognizing traffic-jam passing time information about a time required for passing through the predicted traffic-jam position, wherein
the stop-off information acquirer acquires the stop-off information based on the traffic-jam-passing-time information.

5: The traffic-condition notifying device according to claim 4, wherein the stop-off information acquirer acquires the stop-off information such that, by comparing a total time including a travel time to the stop-off point and a stop-off time to stay at the stop-off point with a traffic-jam passing time required for passing through the predicted traffic-jam position, the total time including the travel time to the stop-off point and the stop-off time to stay at the stop-off point becomes shorter.

6: The traffic-condition notifying device according to claim 1 wherein the stop-off information acquirer acquires the stop-off information such that, by comparing a time required to arrive at the destination with the total time including the travel time to the stop-off point and the stop-off time to stay at the stop-off point, the total time including the travel time to the stop-off point and the stop-off time to stay at the stop-off point becomes shorter.

7: The traffic-condition notifying device according to claim 1, wherein the stop-off information acquirer acquires the stop-off information such that, by comparing a traffic-jam-clearance required time estimated to be required until a traffic jam of the predicted traffic-jam position is cleared up with the total time including the travel time to the stop-off point and the stop-off time to stay at the stop-off point, the total time including the travel time to the stop-off point and the stop-off time to stay at the stop-off point becomes shorter.

8: The traffic-condition notifying device according to claim 1, wherein the stop-off information acquirer acquires the stop-off information when, by comparing a time required to arrive at the destination after passing through the predicted traffic-jam position with a time required to arrive at the destination after stopping off the stop-off point, the time to get to the destination after stopping off the stop-off point is shorter.

9: The traffic-condition notifying device according to claim 1, wherein the stop-off information acquirer recognizes priority information about a priority of the stop-off point, and acquires stop-off information based on the priority information.

10: The traffic-condition notifying device according to claim 9, wherein the stop-off information acquirer acquires stop-off-point-type information about a type of the stop-off point, and sets a priority for each of the stop-off-point-type information.

11: The traffic-condition notifying device according to claim 9, wherein the stop-off information acquirer acquires utilization status information about a utilization status of the stop-off point, and sets the priority information based on the utilization status information.

12: The traffic-condition notifying device according to claim 11, wherein
the utilization status information is congestion level information about congestion status of the stop-off point.

13: The traffic-condition notifying device according to claim 1, further comprising:
a timer for clocking time;
an estimated time information acquirer for acquiring estimated traffic-jam-clearance required time information about an estimated time required for a traffic-jam of the predicted traffic-jam position to be cleared up;
an estimated-required-time computing section for computing an estimated required time including a travel time from the travel route that is set based on the destination information to the stop-off point and a time required to arrive at the travel route from the stop-off point;
an estimated-departure-time computing section for computing an estimated departure time for the mobile body to depart from the stop-off point based on the estimated traffic-jam-clearance required time information and the estimated required time;
a notification information generator for generating departure notification information for prompting departure of the mobile body based on the estimated departure time and a current time clocked by the timer;
a departure-standby status recognizer for recognizing a departure-standby status of the mobile body at the current position; and
a notification controller for setting a timing to notify the departure notification information by the notifier in accordance with the departure-standby status and controls the notifier to notify the departure notification information based on the set timing and the current time.

14: The traffic-condition notifying device according to claim 13, wherein
the traffic-condition notifying device is removably installed in the mobile body,
the departure-standby status recognizer recognizes an installation status of the traffic-condition notifying device to the mobile body, and
the notification controller controls the timing to notify the departure notification information such that a timing to notify the departure notification information by the notifier in a case where the departure-standby status recognizer recognizes non-installation of the traffic-condition notifying device in the mobile body becomes earlier than a timing to notify the departure notification information by the notifier in a case where the departure-standby status recognizer recognizes installation of the traffic-condition notifying device in the mobile body.

15: The traffic-condition notifying device according to claim 13, wherein
the notifier is removably installed in the mobile body,
the departure-standby status recognizer recognizes an installation status of the notifier,
the notification controller controls the timing to notify the departure notification information such that a timing to notify the departure notification information by the notifier in a case where the departure-standby status recognizer recognizes non-installation of the notifier in the mobile body becomes earlier than a timing to notify the departure notification information by the notifier in a case where the departure-standby status recognizer recognizes installation of the notifier in the mobile body.

16: A traffic-condition notifying system, comprising:
a server unit that stores map information in a storage section; and
a terminal unit including a traffic-condition notifying device for acquiring map information from a server unit over a network, wherein
the traffic-condition notifying device includes:
a map information acquirer for acquiring the map information;
a current position recognizer for acquiring current position information about a current position of a mobile body;
a destination recognizer for recognizing destination information about a destination;
a route searcher for searching for a travel route of the mobile body from the current position to the destination;
a traffic-information recognizer for recognizing traffic information about a traffic condition;
a statistical-traffic-information acquirer for acquiring statistical traffic information that is obtained by statistically processing traffic conditions in the past based on time factors;
a traffic-jam-condition change recognizer for recognizing a change over time in the traffic condition of travel route of the mobile body based on the statistical traffic information;
an arrival position recognizer for recognizing a predicted arrival position of the mobile body at a predetermined time;
a predicted traffic-jam position recognizer for recognizing a predicted traffic-jam position at a predetermined time that is estimated based on the change over time in the traffic condition;
a stop-off information acquirer for acquiring, when determining that the mobile body arrives at the predicted traffic-jam position based on the predicted arrival position of the mobile body and the predicted traffic-jam position, stop-off information regarding a stop-off point located in a predetermined distance area from the travel route; and
a notification controller for controlling a notifier to notify the stop-off information.

17: A traffic-condition notifying system, comprising:
a terminal unit including a traffic-condition notifying device; and
a portable device connected to the terminal unit via a network to enable communication therebetween, the portable device including a notifier for notifying the departure notification information that is acquired from the traffic-condition notifying device via the network, wherein
the traffic-condition notifying device includes:
a map information acquirer for acquiring the map information;
a current position recognizer for acquiring current position information about a current position of a mobile body;
a destination recognizer for recognizing destination information about a destination;
a route searcher for searching for a travel route of the mobile body from the current position to the destination;
a traffic-information recognizer for recognizing traffic information about a traffic condition;
a statistical-traffic-information acquirer for acquiring statistical traffic information that is obtained by statistically processing traffic conditions in the past based on time factors;
a traffic-jam-condition change recognizer for recognizing a change over time in the traffic condition of travel route of the mobile body based on the statistical traffic information;
an arrival position recognizer for recognizing a predicted arrival position of the mobile body at a predetermined time;
a predicted traffic-jam position recognizer for recognizing a predicted traffic-jam position at a predetermined time that is estimated based on the change over time in the traffic condition;
a stop-off information acquirer for acquiring, when determining that the mobile body arrives at the predicted traffic-jam position based on the predicted arrival position of the mobile body and the predicted traffic-jam position, stop-off information regarding a stop-off point located in a predetermined distance area from the travel route; and
a notification controller for controlling a notifier to notify the stop-off information.

18: A traffic-condition notifying system, comprising:
a server unit; and
a terminal unit,
the server including:
a current position recognizer for recognizing current position information about a current position of a mobile body;
a destination recognizer for recognizing destination information about a destination;
a route searcher for searching for a travel route of the mobile body from the current position to the destination;
a traffic-information recognizer for recognizing traffic information about a traffic condition;
a statistical-traffic-information acquirer for acquiring statistical traffic information that is obtained by statistically processing traffic conditions in the past based on time factors;
a traffic-jam-condition change recognizer for recognizing a change over time in the traffic condition of travel route of the mobile body based on the statistical traffic information;
an arrival position recognizer for recognizing a predicted arrival position of the mobile body at a predetermined time;
a predicted traffic-jam position recognizer for recognizing a predicted traffic-jam position at a predetermined time that is estimated based on the change over time in the traffic condition; and
a stop-by information acquirer for acquiring, when determining that the mobile body arrives at the predicted traffic-jam position based on the predicted arrival position of the mobile body and the predicted traffic-jam position, stop-by information regarding a stop-by point located in a predetermined distance area from the travel route,
the terminal unit including: a transceiver for acquiring the map information and the stop-off information from the server unit via a network; and
a notifier for notifying the stop-off information.

19: The traffic-condition notifying system according to claim 16, further comprising:
a portable device connected to the server unit via a network to enable communication therebetween, the portable device including a notifier for notifying the departure notification information that is acquired from the server unit via the network.

20: The traffic-condition notifying system according to claim 17, further comprising:
a portable device connected to the server unit via a network to enable communication therebetween, the portable device including a notifier for notifying the departure notification information that is acquired from the server unit via the network.

21: The traffic-condition notifying system according to claim 18, further comprising:
a portable device connected to the server unit via a network to enable communication therebetween, the portable device including a notifier for notifying the departure notification information that is acquired from the server unit via the network.

22: A traffic-condition notifying method, comprising:
recognizing a change over time in a traffic condition based on statistical traffic information that is obtained by statistically processed map information, current position information of a mobile body, destination information, traffic information about a traffic condition and a traffic condition in the past based on time factors;
searching for a travel route from a current position of the mobile body to a destination; and
when determining that, based on a predicted traffic-jam position at a predetermined time that is estimated based on a predicted arrival position of the mobile body at a predetermined time and the change over time in the traffic condition, the mobile body arrives at the predicted traffic-jam position, and determining that the mobile body will be involved in a traffic jam at a predetermined time, acquiring stop-off information about a stop-off point in a predetermined distance area from the travel route to notify the stop-off information by the notifier.

23: A traffic-condition notifying program for operating a computing unit to execute a traffic-condition notifying method, the program stored in a recording medium in a manner readable by the computing unit, wherein
the method includes:
recognizing a change over time in a traffic condition based on statistical traffic information that is obtained by statistically processed map information, current position information of a mobile body, destination information, traffic information about a traffic condition and a traffic condition in the past based on time factors;
searching for a travel route from a current position of the mobile body to a destination; and
when determining that, based on a predicted traffic-jam position at a predetermined time that is estimated based on a predicted arrival position of the mobile body at a predetermined time and the change over time in the traffic condition, the mobile body arrives at the predicted traffic-jam position, and determining that the mobile body will be involved in a traffic jam at a predetermined time, acquiring stop-off information about a stop-off point in a predetermined distance area from the travel route to notify the stop-off information by the notifier.

24: A recording medium that stores a traffic-condition notifying program for operating a computing unit to execute a traffic-condition notifying method in a manner readable by a computing unit, wherein
the method includes:
recognizing a change over time in a traffic condition based on statistical traffic information that is obtained by statistically processed map information, current position information of a mobile body, destination information, traffic information about a traffic condition and a traffic condition in the past based on time factors;
searching for a travel route from a current position of the mobile body to a destination; and
when determining that, based on a predicted traffic-jam position at a predetermined time that is estimated based on a predicted arrival position of the mobile body at a predetermined time and the change over time in the traffic condition, the mobile body arrives at the predicted traffic-jam position, and determining that the mobile body will be involved in a traffic jam at a predetermined time, acquiring stop-off information about a stop-off point in a predetermined distance area from the travel route to notify the stop-off information by the notifier.
